(19) United States
(12) Patent Application Publication
(10) Pub. No.: US 2026/0358475 A1
(43) Pub. Date: Nov. 12, 2026

(54) LIGHT DETECTING DEVICE, AND RANGING SYSTEM

(71) Applicant: Sony Semiconductor Solutions Corporation, Kanagawa (JP)

(72) Inventor: Kosuke Shimizu, Kanagawa (JP)

(21) Appl. No.: 19/138,489

(22) PCT Filed: Jan. 23, 2024
(86) PCT No.: PCT/JP2024/001924

§ 371 Date: Jun. 12, 2025

(30) Foreign Application Priority Data
Jan. 31, 2023 (JP) 2023-013582

(51) Int. Cl. G01S 7/481; G01S 17/931

(52) U.S. Cl. CPC G01S 7/4816; G01S 7/4815; G01S 17/931

(57) ABSTRACT

Light detecting devices and ranging systems with improved accuracy at long-distance ranging are disclosed. In one example, a light detecting device includes a first counter group including first counters, a first pixel circuit group connected to the first counter group, a second counter group including second counters, a second pixel circuit connected to the second counter group, and a switching circuit that switches between counting the number of transitions of an output signal of the first pixel circuit group using the first counter group without using the second counter group and counting the number of transitions using both the first counter group and the second counter group.

### TECHNICAL FIELD

The present disclosure relates to a light detecting device and a ranging system.

### BACKGROUND ART

Proposed is a technology for measuring a distance to an object across short to long ranges using a single photon avalanche diode (SPAD) capable of detecting weak light (see, for example, Patent Documents 1 and 2).

To receive reflected light from the object across short to long ranges, it is necessary to receive the reflected light from the object over a long period of time. Patent Document 1 discloses a configuration where a photon counter that measures the number of times the SPAD detected light (photons) is provided for each pixel, and binning processing that enables the plurality of photon counter provided for the plurality of pixels to operate in a time-division manner to count photons over a long period of time.

### CITATION LIST

### Patent Document

Patent Document 1: Japanese Patent Application Laid-Open No. 2022-73105

Patent Document 2: Japanese Patent Application Laid-Open No. 2021-92437

### SUMMARY OF THE INVENTION

### Problems to be Solved by the Invention

In a case of Patent Document 1, to extend the measurable range, it is necessary to increase the number of pixels subjected to the binning processing, which leads to a decrease in effective resolution.

Furthermore, if the number of pixels of a pixel array unit is increased on the premise of performing the binning processing, the size of the pixel array unit increases, and downsizing becomes difficult accordingly. Furthermore, the larger the number of pixels of the pixel array unit, the more pixel circuits are required, leading to higher power consumption.

It is possible to consider arranging the photon counters arranged on a chip (substrate) different from the pixel array unit and increasing the number of photon counters for each pixel without performing the binning processing, but in that case, the circuit scale of the photon counters becomes larger, making it impossible to downsize the chip.

On the other hand, in a case of Patent Document 2, a histogram generator is provided for each macro pixel including a plurality of pixels. In Patent Document 2, while a counter is not disclosed, the histogram generator essentially has similar functionality as the counter. To perform long-distance ranging using the configuration disclosed in Patent Document 2, it is sufficient to increase the number of histogram generators provided for each macro pixel, but in that case, the circuit scale of the histogram generators becomes larger, making it impossible to downsize the chip on which the histogram generators are implemented, similar to Patent Document 1.

As described above, both Patent Documents 1 and 2 have a common problem that an increase in the number of photon counters or histogram generators for long-distance ranging or the like leads to an increase in the circuit scale, making it impossible to downsize the chip.

It is therefore an object of the present disclosure to provide a light detecting device and a ranging system that allow for an improvement in accuracy of long-distance ranging without increasing the number of pixels.

### Solutions to Problems

In order to solve the above-described problem, according to the present disclosure, there is provided a light detecting device including:
a first counter group including at least two first. counters;
a first pixel circuit or a first pixel circuit group connected to the first counter group;
a first pixel connected to the first pixel circuit or a first pixel group connected to the first pixel circuit group;
a second counter group including at least two second counters;
a second pixel circuit or a second pixel circuit group connected to the second counter group;
a second pixel connected to the second pixel circuit or a second pixel group connected to the second pixel circuit group; and
a switching circuit that switches between counting the number of transitions of an output signal of the first pixel circuit or the first pixel circuit group using the first counter group without using the second counter group and counting the number of transitions using both the first counter group and the second counter group.

The first pixel or the first pixel group may include an active pixel or an active pixel group used to receive reflected light from an object, and
the second pixel or the second pixel group may include an inactive pixel or an inactive pixel group not used to receive the reflected light.

There may be further included a mode selection unit that selects a first mode in which the number of transitions of the output signal of the first pixel circuit or the first pixel circuit group is counted using the first counter group without using the second counter group, or a second mode in which the number of transitions is counted using both the first counter group and the second counter group, in which
the switching circuit may perform switching in accordance with the selection made by the mode selection unit.

Count values of the first counter group and the second counter group may be used to measure a distance to an object,
in a case where the second mode is selected, a measurable range may be longer than in a case where the first mode is selected, and
regardless of whether the first mode or the second mode is selected, a distance resolution and a resolution may be the same.

The measurable range in a case where the second mode is selected may be equal to an integral multiple of at least twice the measurable range in a case where the first mode is selected.

Each of the first and second modes may further include a third mode and a fourth mode that are exclusively selectable,
in the third mode, the number of transitions of the output signal of the first pixel circuit or the first pixel circuit group may be counted using one of the first counter groups, and
in the fourth mode, the number of transitions of the output signal of the first pixel circuit or the first pixel circuit group may be counted using a plurality of the first counter groups.

The fourth mode may further include a fifth mode, a sixth mode, and a seventh mode that are exclusively selectable,
the sixth mode may be longer in measurable range than the fifth mode, lower in distance resolution than the fifth mode, and the same in resolution as the fifth mode, and
the seventh mode may be longer in measurable range than the fifth mode and the same in distance resolution and resolution as the fifth mode.

There may be further included: a first substrate including a pixel array unit in which a plurality of the first pixels or the first pixel groups and a plurality of the second pixels or the second pixel groups are arranged; and
a second substrate in which a plurality of the first pixel circuits or the first pixel circuit groups, a plurality of the first counter groups, a plurality of the second pixel circuits or the second pixel circuit groups, a plurality of the second counter groups, and a plurality of the switching circuits are arranged, the second substrate being stacked on the first substrate.

The plurality of first pixels or the plurality of first pixel groups may be arranged in a predetermined pixel region in the pixel array unit, and
the plurality of second pixels or the plurality of second pixel groups may be arranged in a pixel region other than the predetermined pixel region in the pixel array unit.

There may be further included an output unit that generates output data including first bit string data and second bit string data, the first bit string data including information regarding a mode selected by the mode selection unit, the second bit string data including a count value of the first counter group when the first mode is selected or count values of both the first and second counter groups when the second mode is selected.

The first bit string data may include information regarding the number of the second counter groups connected to the first counter group when the second mode is selected.

The first bit string data may include information used to identify whether to perform binning processing of conducting counting using at least two of the first counter groups or to conduct counting using one of the first counter groups.

The first bit string data may include information used to identify whether to count the number of transitions within a specific pixel region of interest or to count the number of transitions within a predetermined partial pixel region.

The second bit string data may include a plurality of pieces of bit string data in which the count values of the first and second counter groups corresponding to each of all the first pixels are arranged in pixel order when the second mode is selected.

There may be further included: a first pixel array unit in which a plurality of the first pixels or the first pixel groups and a plurality of the second pixels or the second pixel groups and arranged;
a second pixel array unit in which a plurality of third pixels that individually captures subject light is arranged; and
a control unit that controls a light reception range of the second pixel array unit in accordance with a focal length of the subject light incident on the second pixel array unit.

In a case of controlling the focal length of the second pixel array unit toward a telephoto side, the control unit may further reduce a size of a pixel region of the plurality of first pixels or the plurality of first pixel groups in the first pixel array unit.

There may be further included an optical system driving unit that drives a focus-adjustable optical system that adjusts the focal length of the subject light incident on the second pixel array unit, in which
the control unit may control the optical system driving unit on the basis of a measurement result of a distance to the object based on reflected light from the object received by the plurality of first pixels or the plurality of first pixel groups in the first pixel array unit.

According to the present disclosure, there is provided a ranging system including:
a light emitting device that irradiates an object with light;
a light receiving unit that receives reflected light resulting from the light emitted by the light emitting device and reflected by the object;
a ranging unit that measures a distance to the object on the basis of the light emitted by the light emitting device and the reflected light received by the light receiving unit; and
a control unit that controls the light emitting device, the light receiving unit, and the ranging unit, in which
the light receiving unit includes:
a pixel array unit including a plurality of first pixels or first pixel groups and a plurality of second pixels or second pixel groups;
a plurality of first pixel circuits connected to the plurality of first pixels or a plurality of first pixel circuit groups connected to the plurality of first pixel groups;
a first counter group provided for each of the plurality of first pixel circuits or the plurality of first pixel circuit groups, the first counter group including a plurality of first counters;
a plurality of second pixel circuits connected to the plurality of second pixels or a plurality of second pixel circuit groups connected to the plurality of second pixel groups;
a second counter group provided for each of the plurality of second pixel circuits or the plurality of second pixel circuit groups, the second counter group including a plurality of second counters; and
a switching circuit that switches between counting the number of transitions of each of output signals of the plurality of first pixel circuits or the plurality of first pixel circuit groups using the corresponding first counter group without using the corresponding second counter group and counting the number of transitions using both the corresponding first counter group and the corresponding second counter group.

The light emitting device may include a plurality of light emitting units capable of individually controlling whether or not to emit light on the basis of
the control of the control unit, and the control unit may control a size of a light emission area that emits light among the plurality of light emitting units in conjunction with a size of a pixel region of the plurality of first pixels or the plurality of first pixel groups in the pixel array unit.

### BRIEF DESCRIPTION OF DRAWINGS

FIG. 1 is a block diagram illustrating a schematic configuration of a ranging system 2 including a light detecting device according to a first embodiment.

FIG. 2 is a detailed block diagram of the light detecting device illustrated in FIG. 1.

FIG. 3 is a circuit diagram of a pixel of a pixel array unit and an AFE unit of a ranging processing unit.

FIG. 4 is a voltage waveform diagram of a cathode of an SPAD and a pixel signal output from a pixel circuit illustrated in FIG. 3.

FIG. 5A is a circuit diagram illustrating an example of an internal configuration of a generation unit illustrated in FIG. 2.

FIG. 5B is a diagram illustrating an example of a histogram generated by the generation unit.

FIG. 6A is a diagram illustrating a pixel group subjected to binning processing.

FIG. 6B is a circuit diagram illustrating a distribution circuit and a counter group adapted to the binning processing.

FIG. 7 is a schematic perspective view of a semiconductor chip serving as a light detecting device.

FIG. 8 is a circuit diagram of main components of the light detecting device according to the first embodiment.

FIG. 9 is a diagram illustrating a schematic configuration of a ranging system in a case where all light emitting elements simultaneously emit light.

FIG. 10 is a diagram illustrating a schematic configuration of a ranging system in a case where some light emitting elements simultaneously emit light.

FIG. 11 is a diagram illustrating an example where a host control unit controls the light detecting device and a light emitting device according to the first embodiment.

FIG. 12 is a diagram illustrating an example of pixel positions of active pixels and inactive pixels on a pixel array.

FIG. 13 is a diagram illustrating an example where a pixel region other than an ROI area is set as inactive pixels.

FIG. 14 is a diagram illustrating correspondence between active pixels and inactive pixels in a case where a plurality of spot areas is set.

FIG. 15 is a diagram illustrating an example of the count values of a second counter group connected to a first counter group.

FIG. 16 is a diagram illustrating an example of the count values of a first counter group of active pixels and a second counter group of inactive pixels in a case where the second counter group is not used as a part of the first counter group.

FIG. 17 is a circuit diagram of main components of a light detecting device according to a modification of FIG. 8.

FIG. 18 is a diagram summarizing the characteristics of the light detecting device according to the first embodiment.

FIG. 19A is a diagram illustrating a histogram generated in a second comparative example.

FIG. 19B is a diagram illustrating a histogram generated in a third comparative example.

FIG. 19C is a diagram illustrating a histogram generated in a fourth comparative example.

FIG. 20 is a diagram illustrating a configuration of main components of a ranging system including a light detecting device according to a second embodiment.

FIG. 21 is a diagram illustrating main components of a ranging system including an AF lens driver.

FIG. 22 is a flowchart illustrating a processing operation of the ranging system illustrated in FIG. 21.

FIG. 23A is a diagram illustrating a structure of output data in a case where all pixels are active pixels and binning processing is not performed.

FIG. 23B is a diagram illustrating a structure of output data in a case where some pixels are active pixels.

FIG. 23C is a diagram illustrating a structure of output data in a case where binning processing is performed.

FIG. 23D is a diagram illustrating a structure of output data in a case where the first counter group and the second counter group are connected under the condition that both active pixels and inactive pixels are included.

FIG. 24 is a block diagram of main components of a light detecting device 1 according to a fourth embodiment.

FIG. 25 is a block diagram illustrating an example of a schematic configuration of a vehicle control system.

FIG. 26 is an explanatory diagram illustrating an example of installation positions of an outside-vehicle information detecting section and an imaging section.

### MODE FOR CARRYING OUT THE INVENTION

Hereinafter, embodiments of a light detecting device and a ranging system will be described with reference to the drawings. In the following, main components of the light detecting device and the ranging system will be described, but the light detecting device and the ranging system may have components and functions that are not illustrated or described. The following description is not intended to exclude components and functions that are not illustrated or described.

### First Embodiment

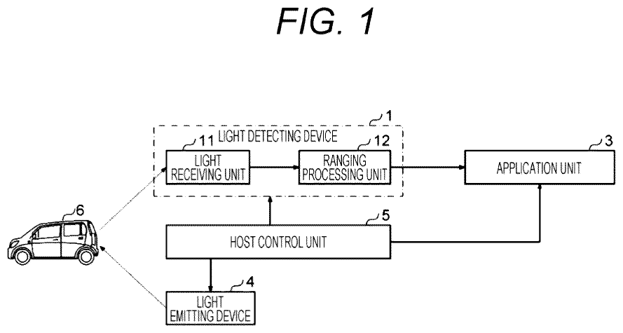

FIG. 1 is a block diagram illustrating a schematic configuration of a ranging system 2 including a light detecting device 1 according to a first embodiment. The ranging system 2 illustrated in FIG. 1 includes the light detecting device 1, an application unit 3, a light emitting device 4, and a host control unit 5.

The light emitting device 4 emits a light pulse signal at regular intervals. The light emitting device 4 can Scan a propagation direction of the light pulse signal in a one-dimensional or two-dimensional direction at predetermined intervals. Furthermore, the light emitting device 4 includes a plurality of light emitting elements, and each light emitting element can individually change the timing of emitting the light pulse signal. This enables the light emitting device 4 to freely change the size and location of a light emission area in which at least two light emitting elements simultaneously emit light.

When an object 6 is irradiated with the light pulse signal emitted from the light emitting device 4, the light detecting device 1 receives a reflected light signal from the object 6. The light detecting device 1 includes a light receiving unit 11 and a ranging processing unit 12. The light receiving unit 11 repeatedly receives the light pulse signal emitted from the light emitting device 4 at regular intervals. The ranging processing unit 12 generates a histogram representing light reception frequency at each light reception timing of the reflected light signal, and measures the distance to the object 6 on the basis of on a peak position of the histogram.

The application unit 3 can perform arbitrary processing using distance data on the object 6 output from the light detecting device 1. For example, the application unit 3 can generate a distance image on the basis of the distance data.

The host control unit 5 controls the light emitting device 4, the light detecting device 1, and the application unit 3. The host control unit 5 may be, for example, a central processing unit (CPU), a personal Computer (PC), a server, or the like. Furthermore, the host control unit 5 may be implemented on the same semiconductor chip as the light detecting device 1.

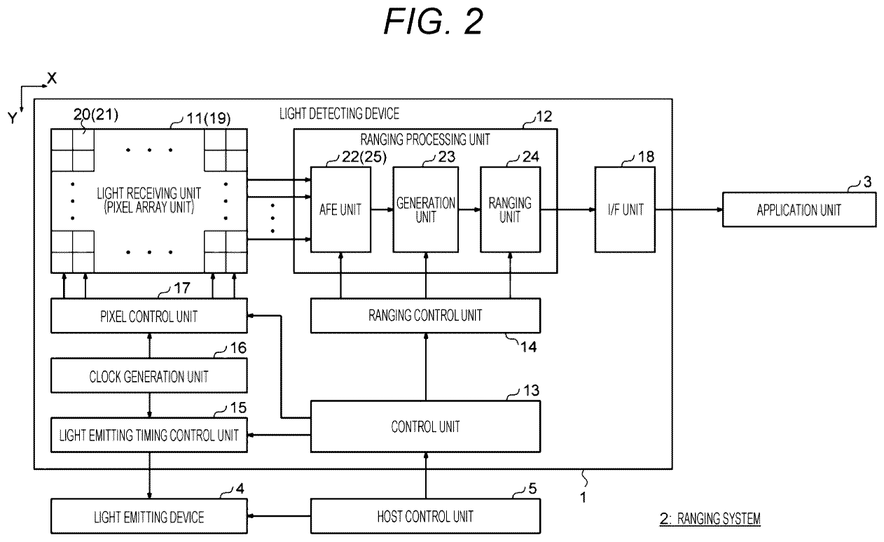

FIG. 2 is a detailed block diagram of the light detecting device 1 in FIG. 1. As illustrated in FIG. 2, the light detecting device 1 includes the light receiving unit 11, the ranging processing unit 12, a control unit 13, a ranging control unit 14, a light emitting timing control unit 15, a clock generation unit 16, a pixel control unit 17, and an interface (I/F) unit 18.

The light receiving unit 11 includes a pixel array unit 19. The pixel array unit 19 includes a plurality of pixels 20 arranged in a first direction X and a second direction Y. Each pixel 20 includes at least one light receiving element. The light receiving element is, for example, a photodiode or an SPAD. Herein, an example where an SPAD 21 is used as the light receiving element will be mainly described.

The pixel control unit 17 can individually control each pixel 20 of the pixel array unit 19 to determine whether or not to cause the pixel 20 to receive the reflected light signal from the object 6. This enables only a pixel region of arbitrary size and location in the pixel array unit 19 to receive the reflected light signal.

The ranging processing unit 12 includes an analog front end unit (hereinafter, referred to as an AFE unit) 22, a generation unit 23, and a ranging unit 24.

The AFE unit 22 includes a plurality of pixel circuits 25 provided on a one-to-one basis for the pixels 20 of the pixel array unit 19. When the corresponding SPAD 21 receives the reflected light signal, each pixel circuit 25 outputs a pixel signal with a predetermined pulse width.

The generation unit 23 generates a histogram on the basis of the output timing and output frequency of the pixel signal output from each pixel circuit 25. The histogram has a number of bins corresponding to the number of pixels receiving the reflected light signal. More specifically, the generation unit 23 includes a counter group including a plurality of counters for each pixel 20. The plurality of counters counts the number of times the corresponding pixel 20 receives the reflected light signal for each timing at which the corresponding pixel 20 receives the reflected light signal. The count value of each counter corresponds to one bin of the histogram. The generation unit 23 generates a histogram having a plurality of bins on the basis of the count values of the plurality of counters.

The ranging unit 24 measures the distance to object 6 on the basis of the peak position of the histogram generated by generation unit 23. The ranging unit 24 may measure the distance by averaging the values (frequencies) of a plurality of bins near the peak position of the histogram.

The control unit 13 controls each unit of the light detecting device 1. The ranging control unit 14 controls the AFE unit 22, the generation unit 23, and the ranging unit 24 of the ranging processing unit 12 in accordance with an instruction from the control unit 13. The pixel control unit 17 controls each pixel 20 of the pixel array unit 19 to determine whether or not to cause the pixel 20 to receive reflected light in accordance with an instruction from the control unit 13. The light emitting timing control unit 15 controls the timing at which each light emitting element of the light emitting device 4 emits the light pulse signal in accordance with an instruction from the control unit 13. At least some of the control unit 13, the ranging control unit 14, the pixel control unit 17, and the light emitting timing control unit 15 may be integrated to form an integrated control unit.

The clock generation unit 16 generates a clock signal for synchronizing each unit of the light detecting device 1. The I/F unit 18 outputs information regarding the distance to the object 6 measured by the ranging processing unit 12.

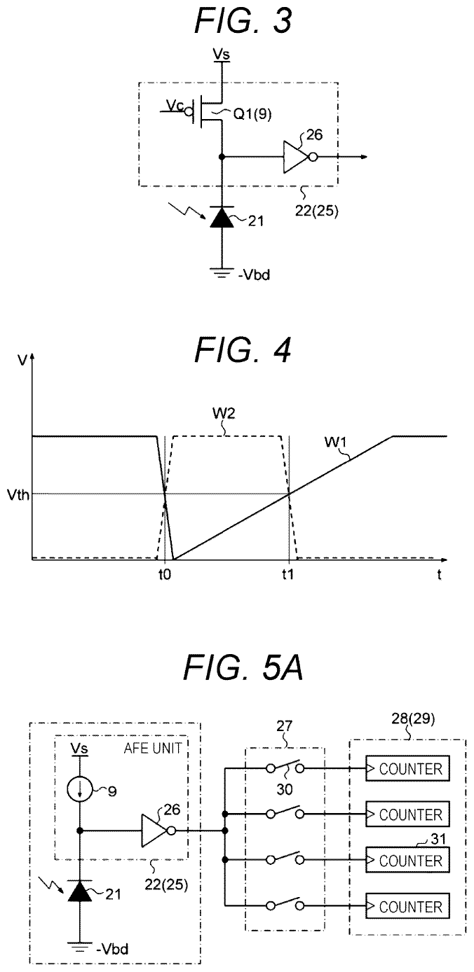

FIG. 3 is a circuit diagram of the pixel 20 of the pixel array unit 19 and the AFE unit 22 of the ranging processing unit 12. The pixel circuit 25 of the AFE unit 22 includes a PMOS transistor Q1 and an inverter 26. The PMOS transistor Q1 has a source connected to a reference voltage node Vs, and has a drain connected to a cathode of the SPAD 21 and an input node of the inverter 26. A control signal Vc from the pixel control unit 17 is input to a gate of the PMOS transistor Q1. With this configuration, the PMOS transistor Q1 functions as a current source 9. The pixel control unit 17 can turn off the PMOS transistor Q1 in accordance with the control signal Vc. This makes it possible to forcibly stop the light receiving operation of the pixel 20. The SPAD 21 has an anode connected to, for example, a negative potential node (−Vbd). The pixel signal is output from an output node of the inverter 26.

FIG. 4 is a voltage waveform diagram of the cathode of the SPAD 21 and the pixel signal output the pixel circuit 25 illustrated in FIG. 3. In FIG. 4, the voltage waveform of the cathode of the SPAD 21 is denoted as W1, and the voltage waveform of the pixel signal is denoted as W2. The cathode of the SPAD 21 remains at the same voltage Vs as the reference voltage node Vs until the SPAD 21 detects photons, and the pixel signal is at a low level. The detection of photons by the SPAD 21 is referred to as firing. When the SPAD 21 fires at time to, the cathode voltage of the SPAD 21 rapidly decreases to become lower than a threshold voltage Vth of the inverter 26. As a result, the pixel signal output from the inverter 26 transitions from a low level to a high level. Thereafter, the cathode voltage of the SPAD 21 gradually increases, and the pixel signal output from the inverter 26 transitions from a high level to a low level at time t1 when the cathode voltage exceeds the threshold voltage Vth of the inverter 26.

As described above, when the SPAD 21 fires, the pixel circuit 25 outputs the pixel signal with a predetermined pulse width. Therefore, the pixel circuit 25 converts the firing of the SPAD 21 into a digitized pixel signal and outputs the pixel signal.

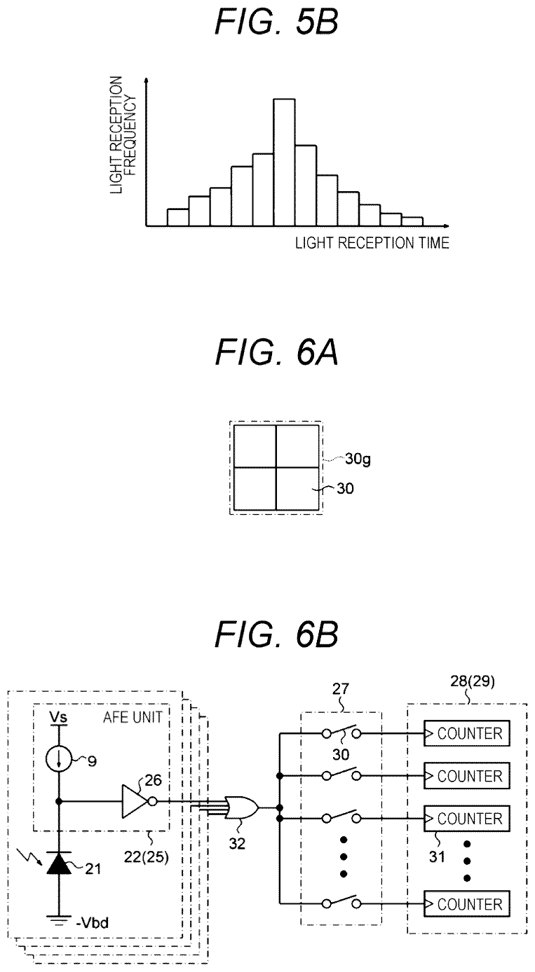

FIG. 5A is a circuit diagram illustrating an example of the internal configuration of the generation unit 23 illustrated in FIG. 2, and FIG. 5B is a diagram illustrating an example of the histogram generated by the generation unit 23. As illustrated in FIG. 5A, the generation unit 23 includes a distribution circuit 27 and a histogram generation unit 29 including a counter group 28. The distribution circuit 27 includes a plurality of switches 30. The counter group 28 in the histogram generation unit 29 includes a plurality of counters 31 equal in number to the switches 30.

Each of the plurality of switches 30 is associated with one of the counters 31 of the counter group 28. The count value of each of the plurality of counters 31 constituting the counter group 28 corresponds to the frequency value of one of the bins of the histogram illustrated in FIG. 5B.

Each of the plurality of switches 30 switches whether or not to cause the corresponding counter 31 to count the number of transitions of the pixel signal output from the corresponding pixel circuit 25. The plurality of switches 30 performs the switching operation on the basis of an instruction from the ranging control unit 14. The ranging control unit 14 controls the switching timing of the plurality of switches 30 in accordance with the elapsed time since the light emitting device 4 emits the light pulse signal. Herein, enabling the counter 31 connected to the switch 30 to perform the counting operation is referred to as “turning on the switch 30”. The plurality of switches 30 is turned on at. different timings. This causes each of the plurality of counters 31 to measure the light reception frequency of the reflected light signal as a count value for each time the light receiving unit 11 receives the reflected light signal.

In the present embodiment, it is possible to perform binning processing of conducting counting the reflected light signals received by a pixel group including at least two pixels 20 (for example, four pixels) using a plurality of counter groups 28 of the pixel group. It is possible to count, by performing the binning processing, the reflected light signals from a long distance, allowing an increase in measurable range.

FIG. 6A is a diagram illustrating a pixel group 30g to be subjected to the binning processing, and FIG. 6B is a circuit diagram illustrating the distribution circuit 27 and the counter group 28 adapted to the binning processing.

FIG. 6A illustrates an example where the binning processing is performed using the pixel group 30g of 2×2 pixels 20 as a unit, but the number of pixels belonging to the pixel group 30g serving as units for the binning processing is freely determined.

The distribution circuit 27 illustrated in FIG. 6B includes a plurality of switches 30 and an OR circuit 32. The OR circuit 32 performs a logical OR operation on the plurality of pixel signals output from all the pixel circuits 25 belonging to the pixel group 30g serving as units for the binning processing. The pixel circuit 25 connected to each pixel 20 that has received the reflected light signal outputs a pixel signal including a high-level pulse signal. With this configuration, when at least one pixel 20 belonging to the pixel group 30g serving as units for the binning processing receives the reflected light signal, at least one output pixel signal becomes a high-level pulse signal, and the output signal of the OR circuit 32 becomes high level. The plurality of switches 30 performs the switching operation in accordance with an instruction from the ranging control unit 14. When the output signal of the OR circuit 32 becomes high level, the count value of the corresponding counter 31 is incremented via any one of the switches 30. Although not illustrated in FIG. 6B, the plurality of counter groups 28 is provided for the pixel group 30g serving as units for the binning processing, so that it is possible to measure, using these counter groups 28, the count value corresponding to the reflected light signal from an object located at a distance, thereby improving the ranging accuracy of objects located at a distance.

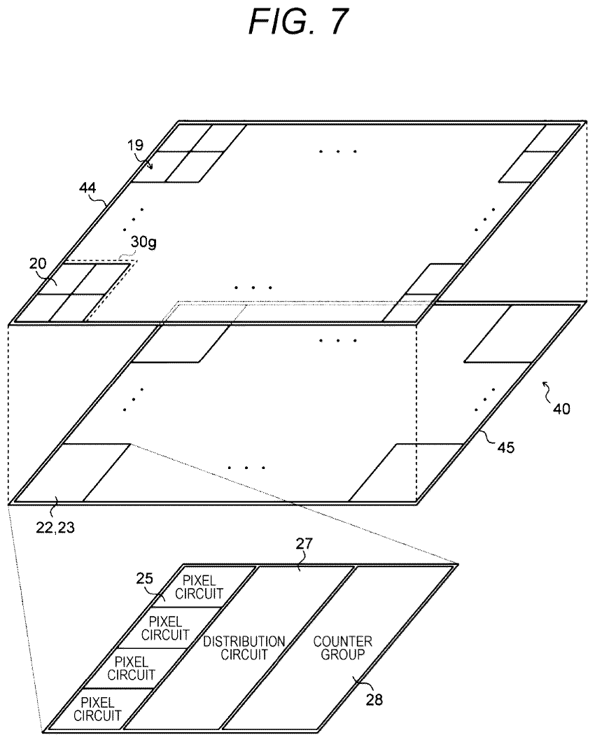

The light detecting device 1 according to the present embodiment can be configured using a stacked semiconductor chip. FIG. 7 is a schematic perspective view of a semiconductor chip 40 equipped with the capabilities of the light detecting device 1. The semiconductor chip 40 illustrated in FIG. 7 includes a stack of first and second substrates 44 and 45. The first substrate 44 is arranged on a surface side on which the reflected light signal is incident. The second substrate 45 is stacked on the first substrate 44 on the side opposite to the incident surface described above.

On the first substrate 44, the pixel array unit 19 is arranged. In a more specific example, the pixel array unit 19 is arranged over nearly the entire surface of the first substrate 44 on which the reflected light signal is incident. In the pixel array unit 19, a plurality of pixels 20 is arranged. On the second substrate 45, the AFE unit 22 including a plurality of pixel circuits 25, the generation unit 23, and the ranging unit 24 are arranged. Note that at least a part of the generation unit 23 and the ranging unit 24 may be arranged on the first substrate 44. Alternatively, at least a part of the generation unit 23 and the ranging unit 24 may be arranged on a third substrate (not illustrated) stacked on the second substrate 45. The third substrate may be provided on a semiconductor chip different from the semiconductor chip 40 including the first substrate 44 and the second substrate 45, rather than being stacked on the first substrate 44 and the second substrate 45.

Various signal transmissions between the first substrate 44 and the second substrate 45 are performed via vias, Cu—Cu bonding, bumps, wiring patterns, or the like.

Similar to FIG. 6A, FIG. 7 illustrates an example where the binning processing can be performed with 2×2 pixels, but the number of pixels serving as units for the binning processing is freely determined.

The pixels 20 of the pixel array unit 19 included in the light receiving unit 11 can be associated with the plurality of light emitting elements included in the light emitting device 4 on a one-to-one basis. In this case, the larger the number of light emitting elements that simultaneously emit light among the plurality of light emitting elements, the larger the number of pixels that receive the reflected light signal in the pixel array unit 19 of the light receiving unit 11. In a case where the light emitting device 4 includes a surface-emitting element such as a vertical cavity surface emitting laser (VCSEL), the larger the number of light emitting elements that simultaneously emit light in the light emitting device 4, the lower the light emission intensity of each light emitting element, and the lower the S/N ratio when the light receiving element receives the reflected light signal. When the light emission intensity of each light emitting element decreases, the light pulse signal does not travel long distances, thereby decreasing the distance accuracy of the object 6 located at a distance.

Therefore, in order to increase the accuracy of distance measurement of the distant object 6, it is desirable to cause only some light emitting elements among the plurality of light emitting elements included in the light emitting device 4 to simultaneously emit light to ensure that the light emission intensity of each light emitting element does not become too low. The fewer the number of light emitting elements that simultaneously emit light in the light emitting device 4, the fewer the number of pixels 20 that receive the reflected light signal in the light receiving unit 11.

It is therefore desirable that the control unit 13 control the number of pixels 20 that receive the reflected light signal in the light receiving unit 11 in accordance with the number of light emitting elements that simultaneously emit the light signal in the light emitting device 4 to prevent the light receiving unit 11 from consuming unnecessary power.

Herein, a pixel 20 that receives the reflected light signal is referred to as an active pixel (first pixel) 20a, and a pixel 20 that does not receive the reflected light signal is referred to as an inactive pixel (second pixel) 20n. The active pixel 20a is arranged in a predetermined pixel region within the pixel array unit 19, and the inactive pixel 20n is arranged in a pixel region other than the predetermined pixel region within the pixel array unit 19. In accordance with an instruction from the control unit 13, the pixel control unit 17 turns on the PMOS transistor Q1 connected to the cathode of the SPAD 21 of the active pixel 20a to activate the current source 9, and turns off the PMOS transistor Q1 connected to the cathode of the SPAD 21 of the inactive pixel 20n to stop the current source 9. This configuration prevents the reference voltage Vs from being supplied to the cathode of the SPAD 21 of the inactive pixel 20n, so that the light reception of the inactive pixel 20n can be forcibly stopped, and the power consumption of the light receiving unit 11 can be reduced.

As described above, since the inactive pixel 20n does not receive the reflected light signal, the counter group 28 arranged downstream of the SPAD 21 is not used. Therefore, in the first embodiment, the counter group 28 of the inactive pixels 20n can be used as a part of the counter group 28 of the active pixels 20a. In this case, the second counter group 28n is used while being connected to the counter group 28.

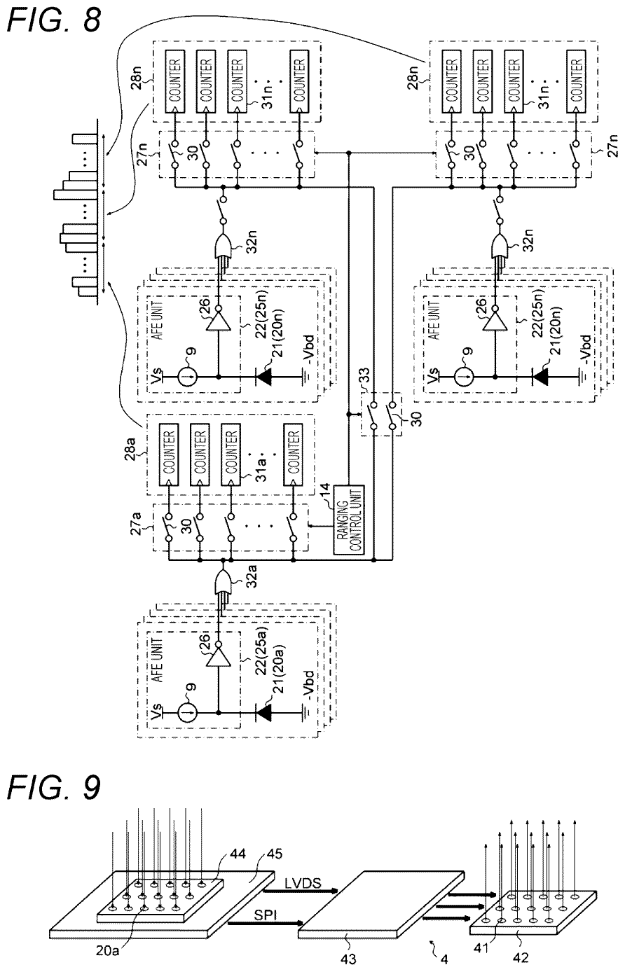

Note that, herein, as illustrated in FIG. 8 to be described later, a counter group 28 provided for the active pixels 20a is referred to as a first counter group 28a, each counter 31 constituting the first counter group 28a is referred to as a first counter 31a, a counter group 28 provided for the inactive pixels 20n is referred to as a second counter group 28n, and each counter 31 constituting the second counter group 28n is referred to as a second counter 31n.

FIG. 8 is a circuit diagram of main components of the light detecting device 1 according to the first embodiment. FIG. 8 illustrates a configuration capable of performing the binning processing. FIG. 8 illustrates a configuration of pixel circuits 25 and the like connected to four active pixels 20a serving as units for the binning processing and eight inactive pixels 20n.

As illustrated in FIG. 8, the light detecting device 1 according to the first embodiment includes pixel circuits 25 connected to the active pixels 20a (hereinafter, referred to as active pixel circuits 25a), a first distribution circuit 27a connected to the active pixel circuits 25a, a first counter group 28a connected to the first distribution circuit 27a, pixel circuits 25 connected to the inactive pixels 20n (hereinafter, referred to as inactive pixel circuits 25n), a second distribution circuit 27n connected to the inactive pixel circuits 25n, a second counter group 28n connected to the second distribution circuit 27n, and a counter switching circuit 33 that switches whether or not to connect the second counter group 28n to the first counter group 28a.

The counter switching circuit 33 switches between Connecting one end of the second distribution circuit 27n connected to the inactive pixels 20n to the second counter group 28n and connecting one end of the second distribution circuit 27n to one end of the first distribution circuit 27a connected to the active pixels 20a. That is, the counter switching circuit 33 switches between counting the number of transitions of the pixel signals output from the active pixel circuits 25a using the first count group without using the second counter group 28n and counting the number of transitions using both the first counter group 28a and the second counter group 28n.

The first distribution circuit 27a, the second distribution circuit 27n, and the counter switching circuit 33 each includes a plurality of switches 30. Each switch 30 is subjected to switching control by the ranging control unit 14.

The second distribution circuit 27n includes a plurality of switches 30 connected to the second counter group 28n and a switch 30 that switches between connecting the other ends of the plurality of switches 30 to the OR circuit 32 and connecting the other ends of the plurality of switches 30 to the counter switching circuit 33. The counter switching circuit 33 includes a switch 30 connected between one end of the first distribution circuit 27a and one end of the second distribution circuit 27n.

In a case of performing long-distance ranging, the ranging control unit 14 performs switching control on the counter switching circuit 33 to connect the second Counter group 28n connected to the inactive pixels 20n to the first counter group 28a. As a result, each of the second counters 3 in constituting the second counter group 28n is used to generate data of some bins of the histogram generated on the basis of the result of receiving light by the active pixels 20a.

The ranging control unit 14 functions as a mode selection unit that selects either a first mode in which the number of transitions of the pixel signals output from the active pixel circuits 25a is counted using the first counter group 28a without using the second counter group 28n or a second mode in which the number of transitions is counted using both the first counter group 28a and the second counter group 28n.

The count values of the first counter group 28a and the second counter group 28n are used to measure the distance to the object 6. In a case where the second mode is selected, the measurable range becomes longer than in a case where the first mode is selected. As a specific example, the measurable range in a case where the second mode is selected is equal to an integral multiple of at least twice the measurable range in a case where the first mode is selected. Regardless of whether the first mode or the second mode is selected, the distance resolution and the resolution are the same.

The first mode and the second mode may each have a third mode and a fourth mode that are exclusively selectable. In the third mode, one first counter group 28a is used to count the number of transitions of the signals output from the first pixel circuits 25. The third mode is a mode in which all the pixels 20 of the pixel array unit 19 are active pixels 20a and the binning processing is not performed. In the fourth mode, a plurality of first counter groups 28a is used to count the number of transitions of the signals output from the first pixel circuits 25. The fourth mode is a mode in which all the pixels 20 of the pixel array unit 19 are active pixels 20a and the binning processing is performed.

The fourth mode may have a fifth mode, a sixth mode, and a seventh mode that are exclusively selectable. The sixth mode is longer in the measurable range than the fifth mode, lower in the distance resolution than the fifth mode, and the same in the resolution as the fifth mode. The seventh mode is longer in the measurable range than the fifth mode, and the same in the distance resolution and the resolution as the fifth mode.

As described above, it is possible to increase, by connecting the second counter group 28n provided for the inactive pixels 20n to the first counter group 28a, the number of bins of the histogram, thereby improving the accuracy of long-distance ranging.

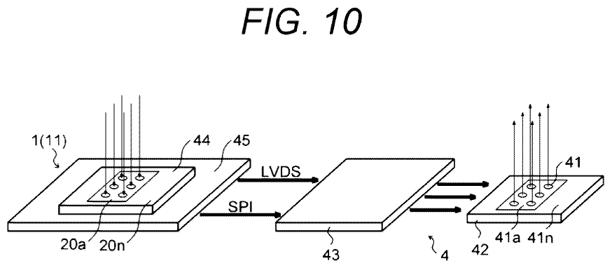

FIGS. 9 and 10 are diagrams illustrating a schematic configuration of the ranging system 2 including the light detecting device 1 and the light emitting device 4 according to the first embodiment. FIG. 9 illustrates a state where all the light emitting elements 41 of the light emitting device 4 simultaneously emit light and all the pixels 20 of the light receiving unit 11 receive the reflected light signal. FIG. 10 illustrates a state where some light emitting elements 41 among the plurality of light emitting elements 41 included in the light emitting device 4 simultaneously emit light and some pixels 20 among the plurality of pixels 20 included in the light receiving unit 11 receive the reflected light signal. In FIG. 10, the pixel 20 that receives the reflected light signal serves as the active pixel 20a, and the pixel 20 that does not receive the reflected light signal serves as the inactive pixel 20n.

As illustrated in FIGS. 9 and 10, the light emitting device 4 includes a VCSEL 42 in which the plurality of light emitting elements 41 is arranged in a plane direction to enable surface emission, and a laser diode driver (LDD) 43 that drives the VCSEL 42. The light detecting device 1 includes the first substrate 44 including the pixel array unit 19 in which the plurality of pixels 20 is arranged in a plane direction, and the second substrate 45 stacked on the first substrate 44. Each pixel 20 includes at least one SPAD 21. FIGS. 9 and 10 illustrate an example where the second substrate 45 is larger in area than the first substrate 44, but the size ratio between the first substrate 44 and the second substrate 45 is freely determined.

The light detecting device 1 transmits a signal in a low voltage differential signaling (LVDS) format including distance measurement information regarding the object 6 and a serial peripheral interface (SPI) signal for serial transmission of various control signals to the LDD 43. The LDD 43 controls the light emission area of the VCSEL 42 on the basis of the SPI signal. The SPI signal is an example of a serial communication method, and a control signal of a different communication method may be transmitted from the light detecting device 1 to the LDD 43.

In FIG. 8, an example where the second counter group 28n provided for the inactive pixels 20n is used to expand the bin of the histogram for the active pixels 20a has been described, but the second counter group 28n may be used to expand the bit width of the first counter group 28a provided for the active pixels 20a. In this case, the bit width of each of the first counters 31a constituting the first counter group 28a can be expanded, so that it is possible to repeatedly perform the distance measurement over a longer period of time, thereby improving the accuracy of distance measurement of the object 6.

Note that, in FIGS. 9 and 10, an example where the size of the light emission area of the light emitting device 4 and the size of the pixel region of the active pixels 20a of the pixel array unit 19 are correlated has been described, but they are not necessarily correlated. A technical characteristic of the light detecting device 1 according to the present embodiment is that the second counter group 28n provided for the inactive pixels 20n is connected to the first counter group 28a provided for the active pixels 20a, and the size of the light emission area of the light emitting device 4 and the size of the pixel region of the active pixels 20a of the pixel array unit 19 need not necessarily be correlated.

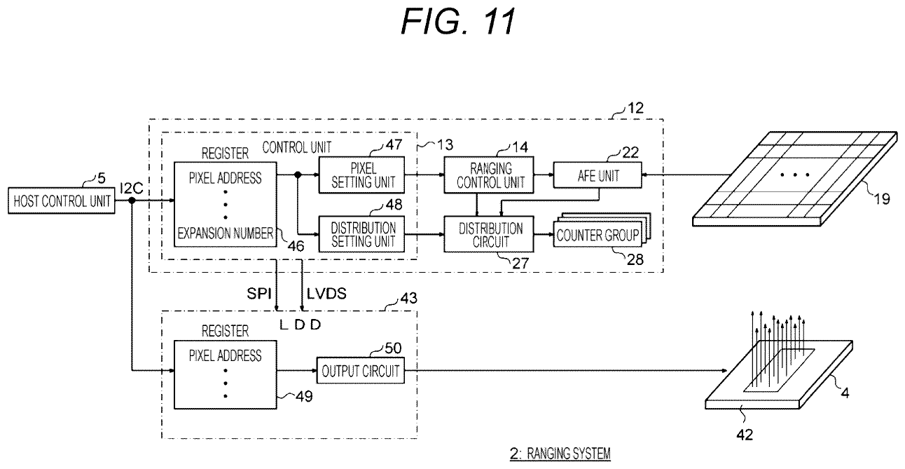

FIG. 11 is a diagram illustrating an example where the host control unit 5 controls the light detecting device 1 and the light emitting device 4 according to the first embodiment. The host control unit 5 controls the control unit 13 of the light detecting device 1 and the LDD 43 of the light emitting device 4 using, for example, an inter-integrated circuit (I2C) signal. Note that the I2C signal is an example, and the host control unit 5 may transmit a control signal of a different communication method to the control unit 13 and the LDD 43.

The I2C signal transmitted from the host control unit 5 to the control unit 13 includes pixel position information regarding the active pixels 20a of the pixel array unit 19. The control unit 13 stores the pixel position information regarding the active pixels 20a transmitted from the host control unit 5 into, for example, a register 46.

The control unit 13 includes a pixel setting unit 47 and a distribution setting unit 48. The pixel setting unit 47 transmits a signal indicating whether each pixel 20 of the pixel array unit 19 is the active pixel 20a or the inactive pixel 20n to the ranging control unit 14 on the basis of the pixel position information regarding the active pixels 20a transmitted from the host control unit 5.

The distribution setting unit 48 transmits, on the basis of the pixel positions of the active pixels 20a transmitted from the host control unit 5, a switching control signal for the plurality of switches 30 included in each of the first distribution circuit 27a, the second distribution circuit 27n, and the counter switching circuit 33 to each switch 30.

The ranging control unit 14 turns on the PMOS transistor Q1 connected to the cathode of the SPAD 21 of each active pixel 20a of the pixel array unit 19 and turns off the PMOS transistor Q1 connected to the cathode of the SPAD 21 of each inactive pixel 20n on the basis of the signal transmitted from the pixel setting unit 47 of the control unit 13.

Furthermore, the ranging control unit 14 supplies the power supply voltage to the AFE unit 22 of the active pixel circuit 25a connected to each active pixel 20a, and stops the supply of the power supply voltage to the AFE unit 22 of the inactive pixel circuit 25n connected to each inactive pixel 20n.

The first distribution circuit 27a, the second distribution circuit 27n, and the counter switching circuit 33 perform switching control to determine whether or not to connect the second counter group 28n to the first counter group 28a on the basis of the signal transmitted from the distribution setting unit 48.

The I2C signal transmitted from the host control unit 5 to the LDD 43 of the light emitting device 4 includes light emission area information regarding the light emitting device 4. The LDD 43 stores the light emission area information transmitted from the host control unit 5 into a register 49. The LDD 43 includes an output circuit 50 that generates a drive signal indicating whether or not to drive each light emitting element 41 of the VCSEL 42 on the basis of the light emission area information. The VCSEL 42 individually controls whether or not to cause each light emitting element 41 to emit light on the basis of the drive signal output from the output circuit 50.

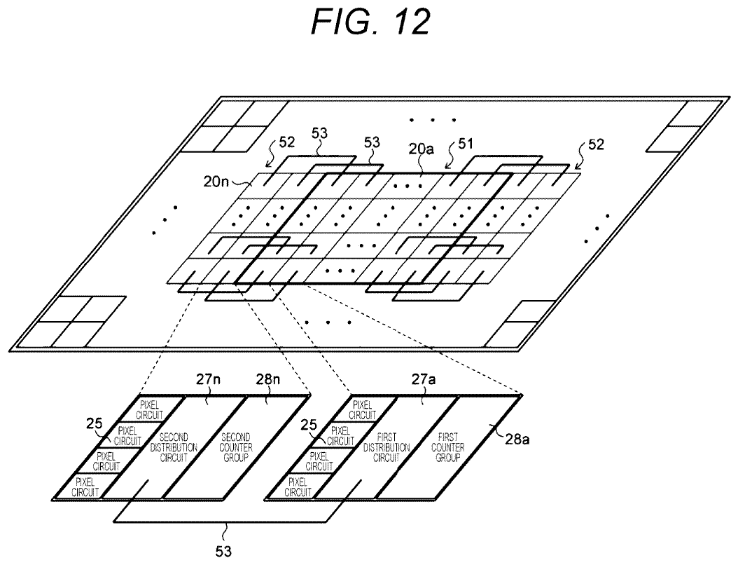

FIG. 12 is a diagram illustrating an example of the pixel positions of the active pixels 20a and the inactive pixels 20n on the pixel array. FIG. 12 illustrates an example where the pixel region of the active pixels 20a is arranged in the center of the pixel array unit 19 and the pixel region of the inactive pixels 20n is arranged around the pixel region of the active pixels 20a. It is possible to connect, by performing switching control on each switch 30 of the second distribution circuit 27n connected to the inactive pixel circuits 25n of the inactive pixels 20n, the second counter group 28n provided for the inactive pixels 20n to the first counter group 28a provided for the active pixels 20a. FIG. 12 schematically illustrates a wiring line 53 connecting the first distribution circuit 27a connected to the first counter group 28a and the second distribution circuit 27n connected to the second counter group 28n.

Note that the first distribution circuit 27a, the second distribution circuit 27n, the counter switching circuit 33, the first counter group 28a, and the second counter group 28n are arranged on the second substrate 44 stacked on the first substrate 45 on which the pixel array unit 19 is arranged. FIG. 12 illustrates a state where the first substrate 44 and the second substrate 45 stacked together are viewed from above.

According to the present embodiment, it is possible to effectively increase the number of the first counters 31a constituting the first counter group 28a while maintaining the resolution of the active pixels 20a. It is therefore possible to increase the number of bins of the histogram to improve the distance accuracy of the object 6 located at a distance.

As described above, it is possible to use the second counter group 28n not only for the purpose of increasing the number of bins of the histogram but also for the purpose of expanding the bit width of each first counter 31a of the first counter group 28a. In this case, the number of repetitions of the distance measurement of the object 6 can be further increased, thereby improving the accuracy of distance measurement.

FIG. 12 illustrates an example where the pixel region of the active pixels 20a is arranged in the center of the pixel array unit 19, but the arrangement of the active pixels 20a in the pixel array unit 19 and the size of the pixel region of the active pixels 20a are freely determined.

Furthermore, in a case where the object 6 is detected at any pixel position of the pixel array unit 19, a region of interest (ROI) area may be set at the position where the object 6 exists in the pixel array unit 19 on the basis of the detection result, and each pixel 20 in the ROI area may be set as the active pixel 20a.

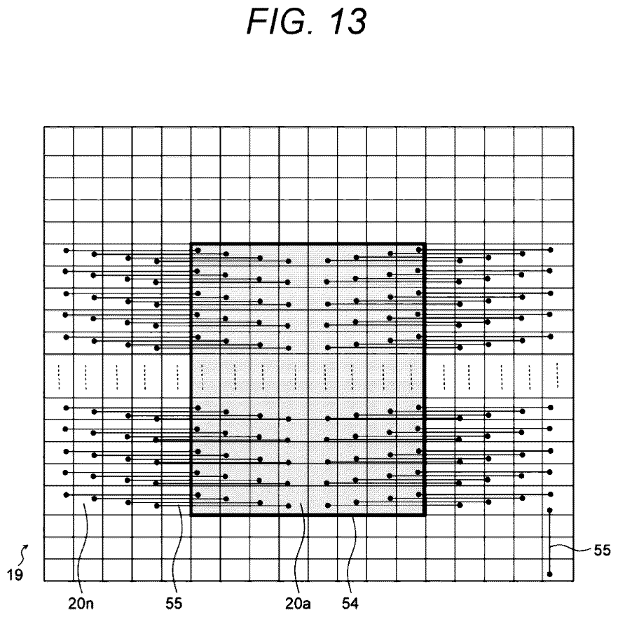

FIG. 13 is a diagram illustrating an example where each pixel 20 in the ROI area 54 serves as the active pixel 20a, and the pixel region other than the ROI area 54 includes the inactive pixels 20n. FIG. 13 illustrates an example where each active pixel 20a in the ROI area 54 is associated with any one of the inactive pixels 20n. FIG. 13 illustrates an example where each active pixel 20a is associated with an inactive pixel 20n located in the first direction X (horizontal direction) outside the ROI area 54. The active pixel 20a and the inactive pixel 20n associated with each other are connected by a wiring line 55. Each wiring line 55 for association extends in the first direction X, and it is possible to reduce variations in signal propagation delay by preventing variations in the length of each wiring line 55.

Note that each active pixel 20a may be associated with an inactive pixel 20n located in the second direction (vertical direction) Y outside the ROI area 54. The size of the ROI area 54 can be further expanded by associating the inactive pixels 20n at pixel positions outside the ROI area 54 with the pixel positions of the active pixels 20a in the ROI area 54.

Furthermore, it is possible to associate two or more inactive pixels 20n with one active pixel 20a. FIG. 13 illustrates an example where the wiring line 55 extending in the second direction Y associates two inactive pixels 20n with one active pixel 20a.

In a case where there is a limitation on the size of the ROI area 54, the pixel region of the inactive pixels 20n can be secured outside the ROI area 54, so that the length of the wiring lines 55 for associating the active pixels 20a with the inactive pixels 20n can be made as short as possible.

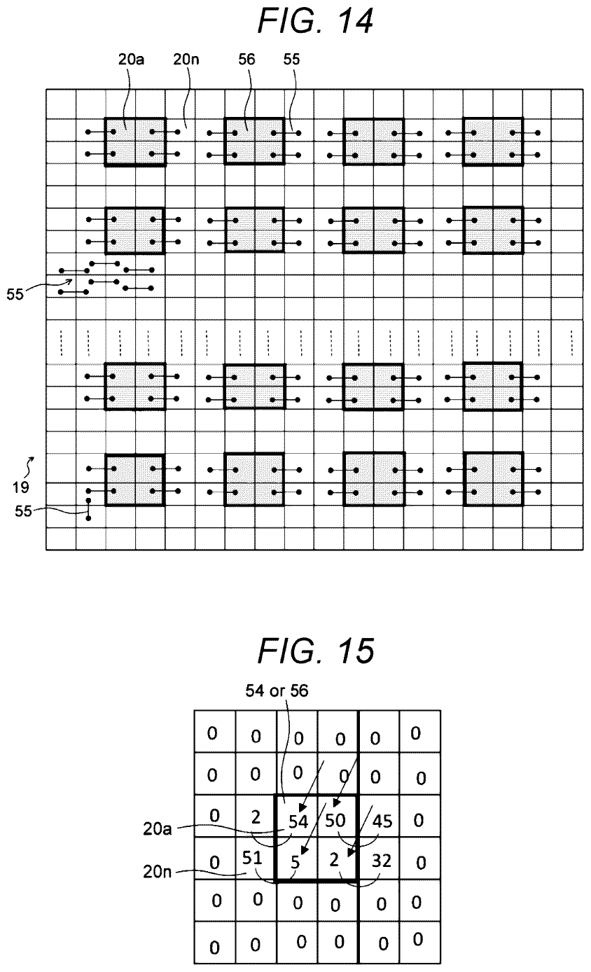

FIG. 14 is a diagram illustrating correspondence between the active pixels 20a and the inactive pixels 20n in a case where a plurality of spot areas 56 is set in the pixel array unit 19. In FIG. 14, each pixel 20 in each spot area 56 serves as the active pixel 20a, and each pixel 20 outside each spot area 56 serves as the inactive pixel 20n.

In FIG. 14, each active pixel 20a in each spot area 56 is associated with an inactive pixel 20n located adjacent to the active pixel 20a outside the spot area 56. This configuration can make the wiring line 55 connecting the active pixel 20a and the corresponding inactive pixel 20n shorter. The pixel position and size of each spot area 56 can be freely controlled on the basis of the pixel position information from the host control unit 5.

The plurality of active pixels 20a included in each spot area 56 illustrated in FIG. 14 may serve as units for the binning processing. Each of the plurality of active pixels 20a serving as units for the binning processing can be associated with the inactive pixel 20n.

Which part of the pixel array unit 19 is set as the spot area 56 is freely determined, the wiring line 55 for associating a plurality of pixels 20 may be provided in advance so that the spot area 56 can be set at any pixel position.

Furthermore, also in FIG. 14, the wiring line 55 for associating two or more inactive pixels 20n with one active pixel 20a may be provided.

Whether to cause all the pixels 20 of the pixel array unit 19 to receive the reflected light signal, to cause only the ROI area 54 illustrated in FIG. 13 to receive the reflected light signal, or to cause only the spot area 56 illustrated in FIG. 14 to receive the reflected light signal may be freely switched.

FIG. 15 is a diagram illustrating an example of the count values of the first counter group 28a for the pixel region (ROI area 54 or spot area 56) of active pixels 20a set in a part of the pixel array unit 19 and the count values of the second counter group 28n connected to the first counter group 28a. As illustrated in the drawing, the count values of the second count group, which are originally supposed to be zero, become non-zero values. The second counter group 28n having non-zero count values is used, for example, as information regarding the Corresponding bin of the histogram.

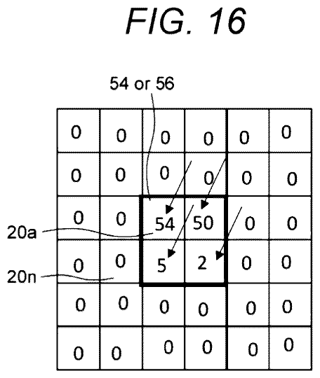

FIG. 16 is a diagram illustrating an example of the count values of the first counter group 28a of the active pixels 20a and the second counter group 28n of the inactive pixels 20n in a case where the second counter group 28n is not used as a part of the first counter group 28a. In a case of FIG. 16, the count values of the second counter group 28n are all zero, and the number of bins of the histogram cannot be expanded accordingly.

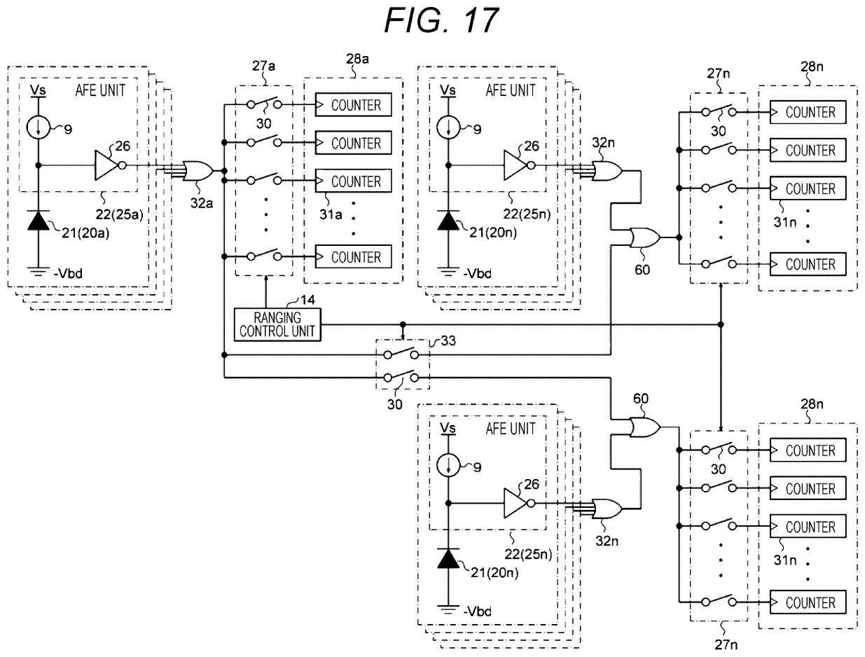

FIG. 17 is a circuit diagram of main components of a light detecting device 1 according to a modification of FIG. 8. In FIG. 17, components common to those in FIG. 8 are denoted by the same reference numerals, and the main differences will be described below.

In FIG. 17, some switches 30 in the second distribution circuit 27n are replaced with OR circuits 60. The OR circuit 60 performs a logical OR operation on the output signal of the OR circuit 32n that performs a logical OR operation on the plurality of pixel signals output from the plurality of inactive pixel circuits 25n and the output signal of an OR circuit 60 that performs a logical OR operation on the plurality of pixel signals output from the plurality of active pixel circuits 25a subjected to the binning processing. The plurality of pixel signals output from the plurality of inactive pixel circuits 25n are always at a low level, so that the output signal of the OR circuit 32 never becomes high level. On the other hand, the OR circuit 32a becomes high level when any one of the plurality of active pixel circuits 25a receives the reflected light signal. Therefore, in a case where the OR circuit 60 is used instead of the switch 30, it is possible to set the output of the OR circuit 60 high level when the output of the OR circuit 32a becomes high level, thereby obtaining the same effect as turning on the switch 30.

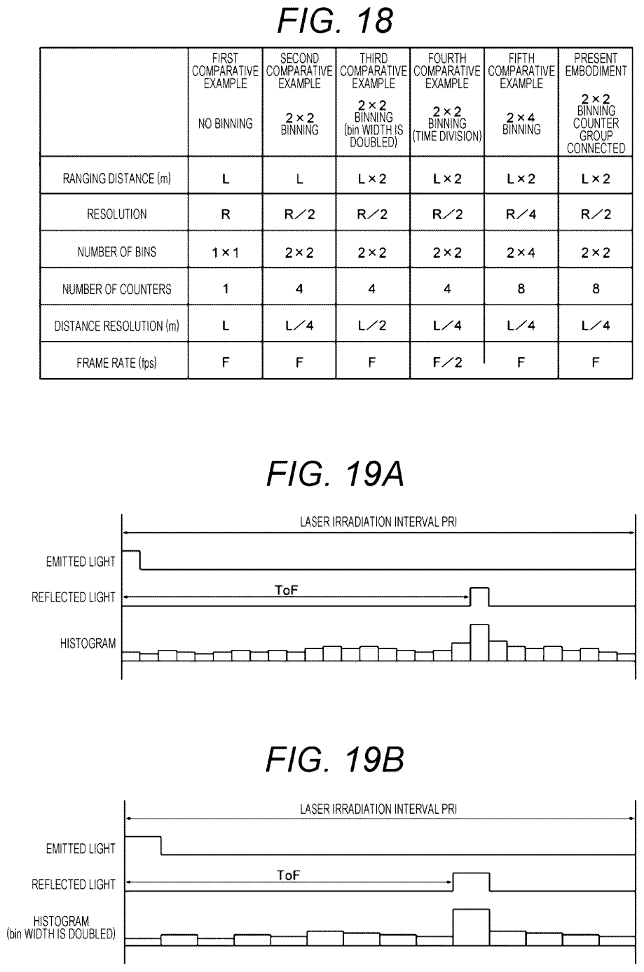

FIG. 18 is a diagram summarizing the characteristics of the light detecting device 1 according to the first embodiment. In FIG. 18, the characteristics of the light detecting device 1 according to the first embodiment are compared to those of first and fifth comparative examples. The first comparative example is an example where all the pixels 20 of the pixel array unit 19 serve as the active pixels 20a and the binning processing is not performed. The second comparative example is an example where the binning processing is performed using 2×2 pixels (hereinafter, binning pixels) of the pixel array unit 19 as a unit. The third Comparative example is an example where the binning processing is performed using 2×2 binning pixels of the pixel array unit 19 as a unit, and the bin width of the histogram that is generated on the basis of the count. values of the first counter group 28a for the binning pixels is doubled. The fourth comparative example is an example where the binning processing is performed using 2×2 binning pixels of the pixel array unit 19 as a unit, and two first counter groups 28a are operated in a time-division manner. The fifth comparative example is an example where the binning processing is performed using 2×4 binning pixels of the pixel array unit 19 as a unit. The light detecting device 1 according to the present embodiment illustrated in FIG. 18 is an example where the binning processing is performed using 2×2 binning pixels of the pixel array unit 19 as a unit, and one second counter group 28n is connected to the first counter group 28a.

In the second comparative example, since the binning processing is performed using 2×2 binning pixels as a unit, the resolution is reduced to ½ compared to the first comparative example, but the number of first counter groups 28a increases by a factor of four, thereby improving the distance resolution by a factor of four compared to the first comparative example. Note that, in FIG. 13, the distance resolution is expressed as L/4, which means that resolution at short distance intervals can be obtained. The second comparative example achieves the same frame rate as that of the first comparative example.

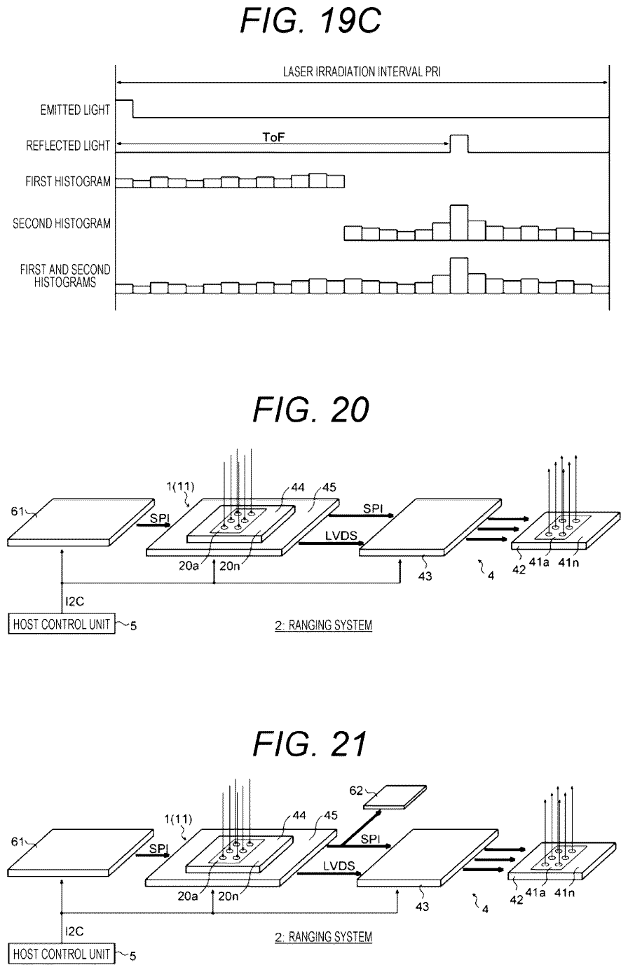

In the third comparative example, since the bin width of the histogram is widened as illustrated in FIG. 19B compared to the histogram illustrated in FIG. 19A generated by the second comparative example, the measurable range is doubled compared to the second comparative example, but the distance resolution is halved. Furthermore, the third comparative example achieves the same resolution and frame rate as those of the second comparative example.

In the fourth comparative example, as illustrated in FIG. 19C, since two first counter groups 28a are operated in a time-division manner to generate two histograms (a first histogram and a second histogram), the measurable range is doubled compared to the first and second comparative examples. On the other hand, the frame rate is halved compared to the first to third comparative examples. Furthermore, the fourth comparative example achieves the same distance resolution as that of the second comparative example.

In the fifth comparative example, since the number of pixels subjected to the binning processing is doubled compared to the second to fourth comparative examples, the resolution increases by a factor of four compared to the first comparative example. Furthermore, in the fifth comparative example, since the number of binning is doubled compared to the second to fourth comparative examples, the number of first counter groups 28a is also doubled. Therefore, in the fifth comparative example, the measurable range is doubled compared to the second comparative example, but the distance resolution is almost the same. The fifth comparative example achieves almost the same frame rate as those of the first to third comparative examples.

The light detecting device 1 according to the present embodiment has almost the same measurable range as those of the third to fifth embodiments, and has almost the same resolution as those of the second to fourth embodiments. Furthermore, the light detecting device 1 according to the present embodiment has almost the same distance resolution as those of the second, fourth, and fifth embodiments. Moreover, the light. detecting device 1 according to the present embodiment has almost the same frame rate as those of the first to third and fifth embodiments.

As described above, in the first embodiment, since the second counter group 28n provided for the inactive pixels 20n can be connected to the first counter group 28a provided for the active pixels 20a, it is possible to expand the number of bins of the histogram for the active pixels 20a, thereby improving the accuracy of distance measurement of the distant object 6. Alternatively, it is possible to use the second counter group 28n to expand the bit width of each first counter 31a constituting the first counter group 28a, thereby improving the accuracy of distance measurement.

In the first embodiment, when the reflected light signal is received only in the spot area 56 or the ROI area 54, the second counter group 20n provided for the inactive pixels 28n can be effectively used. It is therefore possible to accurately measure the distance to the distant object 6 without increasing the number of pixels of the pixel array unit 19.

### Second Embodiment

A light detecting device 1 according to a second embodiment includes not only a light receiving unit 11 for distance measurement but also an imaging unit that captures subject light.

FIG. 20 is a diagram illustrating a configuration of main components of a ranging system 2 including the light detecting device 1 according to the second embodiment. The ranging system 2 in FIG. 20 includes the light detecting device 1, the light emitting device 4, and the host control unit 5. In FIG. 20, components common to those in FIG. 9 are denoted by the same reference numerals, and the main differences will be described below.

Similar to FIG. 7, the light detecting device 1 illustrated in FIG. 20 includes a first substrate 44 on which the light receiving unit 11 is arranged and a second substrate 45 stacked on the first substrate 44. Similar to FIG. 2, a ranging processing unit 12, a ranging control unit 14, a light emitting timing control unit 15, a clock generation unit 16, and an I/F unit 18 are arranged on the second substrate 45.

In addition, the light detecting device 1 illustrated in FIG. 20 includes an imaging unit 61 that captures subject light. The imaging unit 61 is also referred to as an image sensor. The imaging unit 61 is a semiconductor chip different from a semiconductor chip 40 including a stack of the first and second substrates 44 and 45. Alternatively, the imaging unit 61 may be arranged in a vacant area of the first substrate 44.

The imaging unit 61 captures subject light transmitted through a telephoto optical system with a long focal length (not illustrated in FIG. 20). The optical system may be a zoom lens with an adjustable focal length. Alternatively, a first imaging unit that captures subject light transmitted through a telephoto optical system or a second imaging unit that captures subject light transmitted through a wide-angle optical system may be freely selected.

Similar to FIG. 9, the light emitting device 4 includes a VCSEL 42 and an LDD 43. The host control unit 5 controls the imaging unit 61, the light receiving unit 11, and the LDD 43 using, for example, an I2C signal. The imaging unit 61 illustrated in FIG. 20 captures subject light transmitted through a telephoto optical system.

The imaging unit 61, the light receiving unit 11, and the light emitting device 4 illustrated in FIG. 20 operate in conjunction with each other under the control of the host control unit 5. In a case where the imaging unit 61 captures subject light transmitted through the telephoto optical system, the light emitting device 4 narrows the light emission area when measuring the distance to the object 6 located at a distance. The light receiving unit 11 receives the reflected light signal from the object 6 using a spot area 56 of a pixel region with a size corresponding to the light emission area.

On the other hand, in a case where the imaging unit 61 captures subject light for a wide-angle focal length, the light emitting device 4 widens the light emission area, and the light receiving unit 11 receives the reflected light signal from the object 6 using a pixel region with a size corresponding to the light emission area.

FIG. 21 is a diagram illustrating main components of the ranging system 2 including an AF lens driver (optical system driving unit) 62 that variably controls the focal length of a focus-adjustable optical system (AF lens) of the imaging unit 61. The imaging unit 61 transmits, for example, an SPI signal to the light receiving unit 11. The SPI signal includes information regarding the focal length of the AF lens. The light receiving unit 11 transmits the SPI signal to not only the LDD 43 but also the AF lens driver 62. Furthermore, similar to FIG. 20, the host control unit 5 transmits, for example, an I2C signal to the imaging unit 61, the light receiving unit 11, and the LDD 43.

In a case where the imaging unit 61 captures the image of the object 6 located at a distance, the imaging unit 61 transmits the information to that effect using the SPI signal. The SPI signal output from the imaging unit 61 is supplied to the AF lens driver 62 via the light receiving unit 11. The AF lens driver 62 adjusts the focal length of an AF lens (not illustrated). Furthermore, the VCSEL 42 adjusts the light emission area in accordance with the focal length of the AF lens.

Furthermore, the light receiving unit 11 controls the pixel region of the active pixels 20a of the pixel array unit 19 in accordance with the focal length of the AF lens. The control unit 13 controls the AF lens driver 62 on the basis of the result of distance measurement of the object based on the reflected light from the object, the reflected light being received by light receiving unit 11.

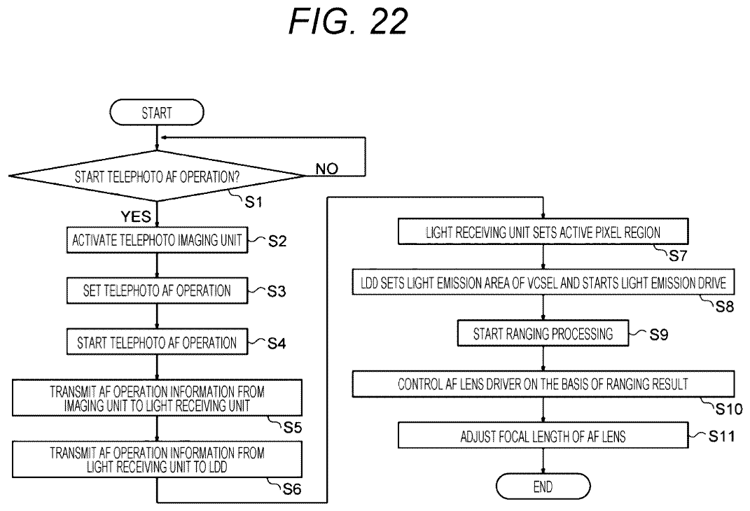

FIG. 22 is a flowchart illustrating a processing operation of the ranging system 2 illustrated in FIG. 21. First, whether or not to start a telephoto auto focus (AF) operation is determined (step S1). The processing stays in step S1 until the telephoto AF operation is started. Alternatively, in a case of not starting the telephoto AF operation, the processing in FIG. 22 may be terminated.

In a case of starting the telephoto AF operation (YES in step S1), the host device activates the telephoto imaging unit 61 (step S2). Next, the host device sets information regarding the telephoto focal length to the imaging unit 61 (step S3). The imaging unit 61 starts a telephoto focus adjustment operation (AF operation) (step S4).

The imaging unit 61 transmits telephoto AF operation information to the light receiving unit 11 using the SPI signal (step S5). The light receiving unit 11 transmits the telephoto AF operation information to the LDD 43 using the SPI signal (step S6).

The light receiving unit 11 sets the pixel region of the active pixels 20a on the basis of the telephoto AF operation information (step S7). The LDD 43 sets the light emission area of the VCSEL 42 on the basis of the telephoto AF operation information, and starts light emission (step S8).

The light receiving unit 11 receives the reflected light signal using the pixel region of the active pixels 20a set in step S7, and starts ranging processing (step S9). The distance to the object 6 is measured on the basis of the result of receiving the reflected light signal by the light receiving unit 11. Specifically, the distance to the object 6 is measured on the basis of the peak position of the histogram, and the AF lens driver 62 is controlled on the basis of the measured distance to the object 6 (step S10). The AF lens driver 62 adjusts the focal length of the AF lens in accordance with the measured distance to object 6 (step S11).

As described above, in the second embodiment, the telephoto imaging unit 61 that captures subject light is provided, and in a case where the imaging unit 61 captures the image of the subject located at a distance, the light emission area of the light emitting device 4 and the pixel region of the active pixels 20a of the light receiving unit 11 are controlled in conjunction with the focal length of the subject light incident on the imaging unit 61. With this configuration, in a case where the imaging unit 61 captures the image of the subject located at a distance, the light emission area of the light emitting device 4 is narrowed, the pixel region of the active pixels 20a of the light receiving unit 11 is narrowed, and the second counter group 28n of the inactive pixels 20n is connected to the first counter group 28a. This allows for an improvement in the accuracy of distance measurement of the object 6 located at a distance.

### Third Embodiment

The third embodiment has distinctive characteristics in the format of output data output from the generation unit 23 in the ranging processing unit 12 of the light detecting device 1 according to the first or second embodiment.

In the light detecting device 1 according to the first or second embodiment, the second counter group 28n provided for the inactive pixels 20n can be connected to the first counter group 28a. It is, however, impossible to determine, only on the basis of the count values of the first counter group 28a and the second counter group 28n, whether the count values represent indicate that the first counter group 28a and the second counter group 28n are connected or the count values represent independent reception results of the reflected light signal.

Therefore, the light detecting device 1 according to the third embodiment is characterized by adding various types of information to the output data output by the generation unit 23 to facilitate the determination of what the count values of the first counter group 28a and the second counter group 28n represent.

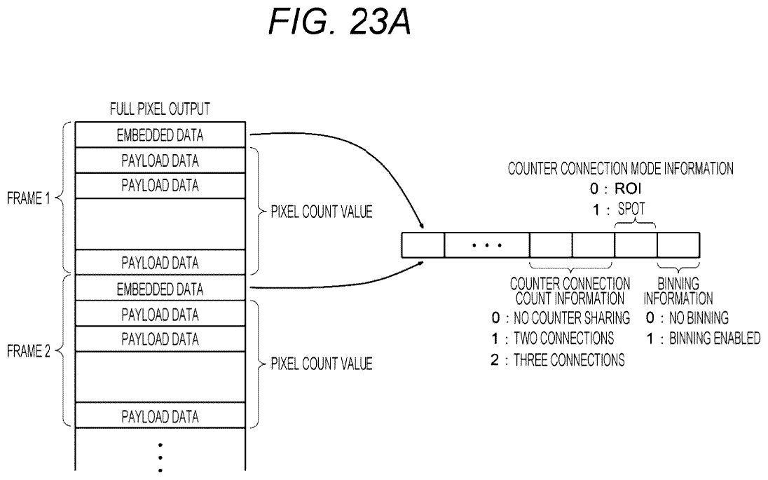

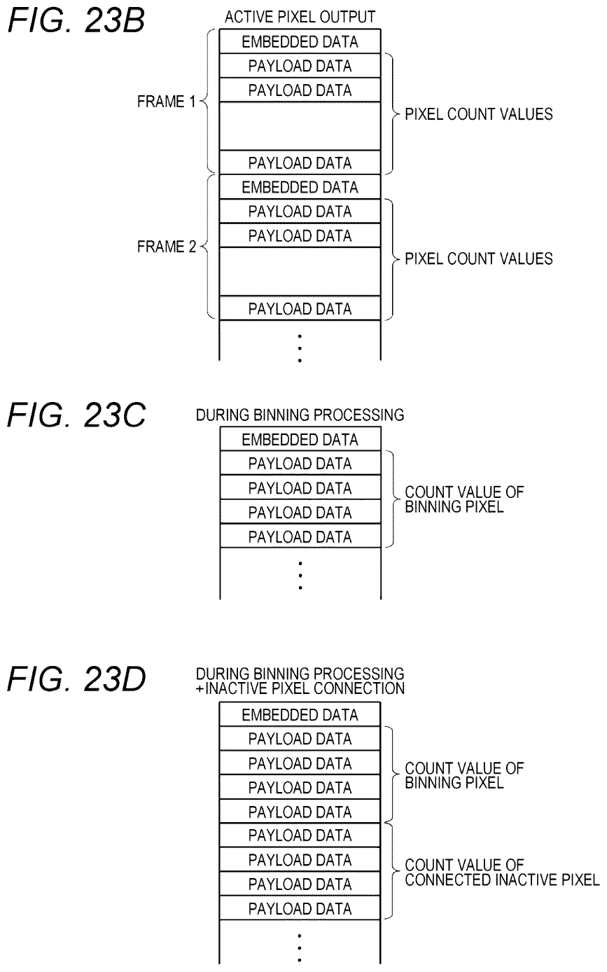

The light detecting device 1 according to the third embodiment has a block configuration similar to that illustrated in FIG. 2. The generation unit 23 of the ranging processing unit 12 outputs, for example, output data in any one of the data formats illustrated in FIG. 23A, FIG. 23B, FIG. 23C, and FIG. 23D. FIG. 23A is a diagram illustrating a structure of output data in a case where all the pixels 20 of the pixel array unit 19 serve as the active pixels 20a and the binning processing is not performed. FIG. 23B is a diagram illustrating a structure of output data in a case where some pixels of the pixel array unit 19 serve as the active pixels 20a. FIG. 23C is a diagram illustrating a structure of output data in a case where the binning processing is performed. FIG. 23D is a diagram illustrating a structure of output data in a case where the first counter group 28a and the second counter group 28n are connected under the condition that both the active pixels 20a and the inactive pixels 20n are included in the pixel array unit 19.

In any of FIGS. 23A to 23D, the output data includes, for each frame, embedded data (first bit string data) and a plurality of pieces of payload data (second bit string data). The embedded data includes information representing characteristics of the payload data, and includes, for example, counter connection count information representing the number of second counter groups 28n connected to the first counter group 28a, counter connection mode information for identifying whether the active pixels 20a are in the ROI area 54 or the spot area 56, and binning information representing whether or not the binning processing is performed. The embedded data may include information other than the three pieces of information illustrated in FIG. 23A.

The output data in a case where all the pixels 20 of the pixel array unit 19 serve as the active pixels 20a and the binning processing is not performed includes payload data for all the pixels 20 in the arrangement order of the pixels 20 as illustrated in FIG. 23A.

As illustrated in FIG. 23C, the output data in a case where the pixel array unit 19 performs the binning processing includes payload data including the count values of a plurality of pixels 20 (hereinafter, referred to as binning pixels) serving as units for the binning processing in the arrangement order of the binning pixels.

As illustrated in FIG. 23D, the output data in a case where the active pixels 20a and the inactive pixels 20n coexist in the pixel array unit 19 includes payload data including the count value of each of the first counters 31a constituting the first counter group 28a and payload data including the count value of each of the second counters 31n constituting the second counter group 28n connected to the first counter group 28a.

Outputting the output data in the data formats illustrated in FIGS. 23A to 23D from the generation unit 23 in the ranging processing unit 12 enables the ranging unit 24 to identify whether or not the binning processing has been performed, whether or not the spot area 56 or the ROI area 54 has been set in the pixel array unit 19, how many second counter groups 28n are connected to the first counter group 28a, and the like, and accurately measure the distance to the object 6.

In the first to third embodiments described above, an example where the pixel array unit 19 and the ranging processing unit 12 including the distribution circuit 27 and the counter group 28 are arranged on separate substrates has been mainly described, but there is no restriction on where the pixel array unit 19 and the ranging processing unit 12 are arranged, and the pixel array unit 19 and the ranging processing unit 12 may be arranged on the same substrate, for example.

Furthermore, the configuration illustrated in FIG. 5A where the counter group 28 is integrated into the histogram generation unit 29 to eliminate the need for a separate counter group 28 may be employed, but even in this case, it is possible to connect a plurality of histogram generation units 29 as necessary by connecting the distribution circuit 27 to the plurality of histogram generation units 29.

### Fourth Embodiment

In the first to third embodiments described above, an example where the counter group 28 is provided for each pixel has been described, but the counter group 28 may be provided for each set of a plurality of pixels. At that time, the counter group 28 may be integrated into the histogram generation unit 29.

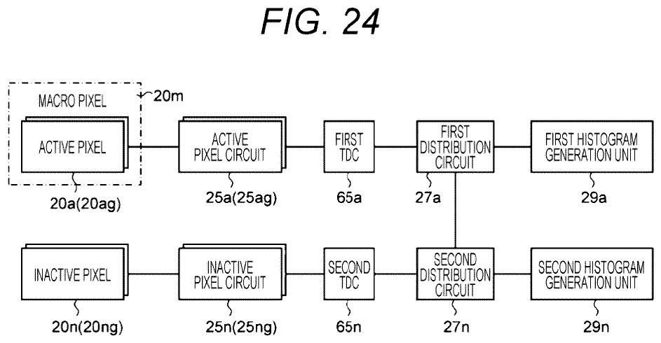

FIG. 24 is a block diagram of main components of a light detecting device 1 according to a fourth embodiment. The light detecting device 1 illustrated in FIG. 24 generates a histogram using a macro pixel 20m including a plurality of active pixels 20a as units or using the plurality of active pixels 20a in the macro pixel 20m as units. The pixel array unit 19 includes at least one macro pixel 20m and a plurality of inactive pixels other than the macro pixel 20m.

The light detecting device 1 illustrated in FIG. 24 includes an active pixel circuit group 25aq, a first TDC 65a, a first histogram generation unit 29a, and a first distribution circuit 27a for each active pixel group 20ag including at least two active pixels 20a belonging to the macro pixel 20m. The first TDC 65a converts a pixel signal output from the active pixel circuit group 25ag into a time digital signal. The first histogram generation unit 29a generates a histogram on the basis of the time digital signal. The first distribution circuit 27a is arranged between the first IDC 65a and the first histogram generation unit 29a.

Furthermore, the light detecting device illustrated in FIG. 24 includes an inactive pixel circuit group 25ng, a second TDC 65n, a second histogram generation unit 29n, and a second distribution circuit 27n for each inactive pixel group 20ng including at least two inactive pixels 20n.

The first histogram generation unit 29a and the second histogram generation unit 29n each have a function of counting the time digital signal.

The first distribution circuit 27a and the second distribution circuit 27n are subjected to switching control by the ranging control unit 14 illustrated in FIG. 2. For example, in a case where long-distance ranging is performed, the ranging control unit 14 can connect the second histogram generation unit 29n corresponding to the inactive pixel group 20ng to the first histogram generation unit 29a.

As described above, in the fourth embodiment, the first histogram generation unit 29a for each set of a plurality of active pixels 20a and the second histogram generation unit 29n for each set of a plurality of inactive pixels 20n are provided. In the fourth embodiment, the second histogram generation unit 29n can be connected to the first histogram generation unit 29a as necessary, and similar to the first to third embodiments, it is possible to perform the ranging processing for long-distance ranging using more counters (histogram generation units) without increasing the total number of counters.

### APPLICATION EXAMPLE

The technology according to the present disclosure can be applied to various products. For example, the technology according to the present disclosure may also be implemented as a device mounted on any type of mobile body such as an automobile, an electric vehicle, a hybrid electric vehicle, a motorcycle, a bicycle, a personal mobility, an airplane, a drone, a vessel, a robot, a construction machine, or an agricultural machine (tractor).

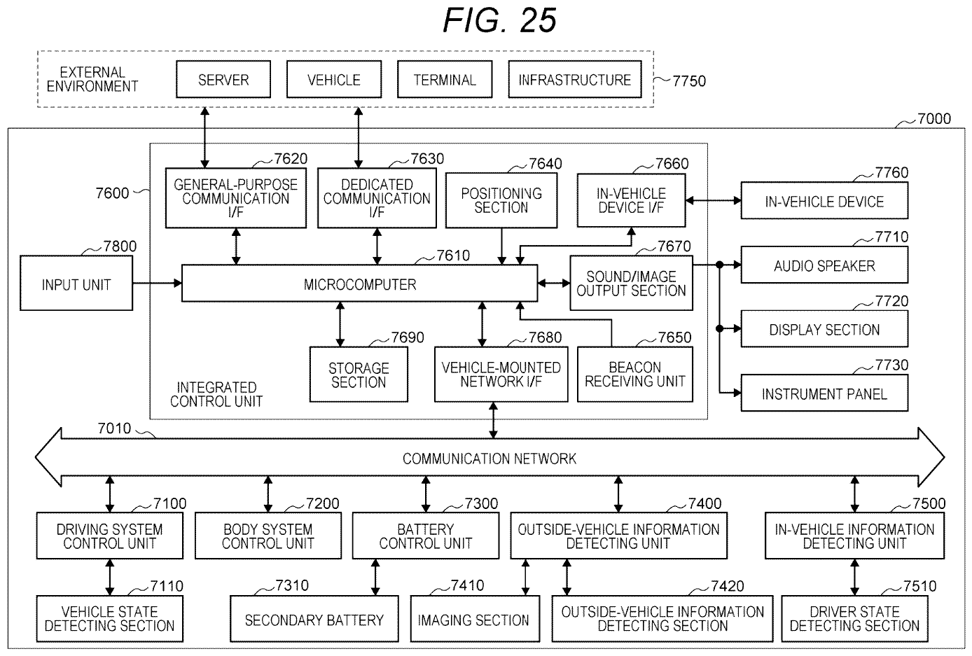

FIG. 25 is a block diagram illustrating an example of a schematic configuration of a vehicle control system 7000 as an example of a mobile body control system to which the technology according to the present disclosure can be applied. The vehicle control system 7000 includes a plurality of electronic control units connected to each other via a communication network 7010. In the example illustrated in FIG. 25, the vehicle control system 7000 includes a driving system control unit 7100, a body system control unit 7200, a battery control unit 7300, an outside-vehicle information detecting unit. 7400, an in-vehicle information detecting unit 7500, and an integrated control unit 7600. The communication network 7010 connecting the plurality of control units to each other may, for example, be a vehicle-mounted communication network compliant with an arbitrary standard such as controller area network (CAN), local interconnect network (LIN), local area network (LAN), FlexRay (registered trademark), or the like.

Each of the control units includes: a microcomputer that performs arithmetic processing according to various kinds of programs; a storage section that stores the programs executed by the microcomputer, parameters used for various kinds of operations, or the like; and a driving circuit that drives various kinds of control target devices. Each of the control units further includes: a network interface (I/F) for performing communication with other control units via the communication network 7010; and a communication I/F for performing communication with a device, a sensor, or the like within and without the vehicle by wire communication or radio communication. Functional components of the integrated control unit 7600 illustrated in FIG. 25 include a microcomputer 7610, a general-purpose communication I/F 7620, a dedicated communication I/F 7630, a positioning section 7640, a beacon receiving section 7650, an in-vehicle device I/F 7660, a sound/image output section 7670, a vehicle-mounted network I/F 7680, and a storage section 7690. The other control units similarly include a microcomputer, a communication I/F, a storage section, and the like.

The driving system control unit 7100 controls the operation of devices related to the driving system of the vehicle in accordance with various kinds of programs. For example, the driving system control unit 7100 functions as a control device for a driving force generating device for generating the driving force of the vehicle, such as an internal combustion engine, a driving motor, or the like, a driving force transmitting mechanism for transmitting the driving force to wheels, a steering mechanism for adjusting the steering angle of the vehicle, a braking device for generating the braking force of the vehicle, and the like. The driving system control unit 7100 may have a function as a control device of an antilock brake system (ABS), electronic stability control (ESC), or the like.

The driving system control unit 7100 is connected with a vehicle state detecting section 7110. The vehicle state detecting section 7110, for example, includes at least one of a gyro sensor that detects the angular velocity of axial rotational movement of a vehicle body, an acceleration sensor that detects the acceleration of the vehicle, and sensors for detecting an amount of operation of an accelerator pedal, an amount of operation of a brake pedal, the steering angle of a steering wheel, an engine speed or the rotational speed of wheels, and the like. The driving system control unit 7100 performs arithmetic processing using a signal input from the vehicle state detecting section 7110, and controls the internal combustion engine, the driving motor, an electric power steering device, the brake device, and the like.

The body system control unit 7200 controls the operation of various kinds of devices provided to the vehicle body in accordance with various kinds of programs. For example, the body system control unit 7200 functions as a control device for a keyless entry system, a smart key system, a power window device, or various kinds of lamps such as a headlamp, a backup lamp, a brake lamp, a turn signal, a fog lamp, or the like. In this case, radio waves transmitted from a mobile device as an alternative to a key or signals of various kinds of switches can be input to the body system control unit 7200. The body system control unit 7200 receives these input radio waves or signals, and controls a door lock device, the power window device, the lamps, or the like of the vehicle.

The battery control unit 7300 controls a secondary battery 7310, which is a power supply source for the driving motor, in accordance with various kinds of programs. For example, the battery control unit 7300 is supplied with information about a battery temperature, a battery output voltage, an amount of charge remaining in the battery, or the like from a battery device including the secondary battery 7310. The battery control unit 7300 performs arithmetic processing using these signals, and performs control for regulating the temperature of the secondary battery 7310 or controls a cooling device provided to the battery device or the like.

The outside-vehicle information detecting unit 7400 detects information about the outside of the vehicle including the vehicle control system 7000. For example, the outside-vehicle information detecting unit 7400 is connected with at least one of an imaging section 7410 and an outside-vehicle information detecting section 7420. The imaging section 7410 includes at least one of a time-of-flight (ToF) camera, a stereo camera, a monocular camera, an infrared camera, and other cameras. The outside-vehicle information detecting section 7420, for example, includes at least one of an environmental sensor for detecting current atmospheric conditions or weather conditions and a peripheral information detecting sensor for detecting another vehicle, an obstacle, a pedestrian, or the like on the periphery of the vehicle including the vehicle control system 7000.

The environmental sensor, for example, may be at least one of a rain drop sensor detecting rain, a fog sensor detecting a fog, a sunshine sensor detecting a degree of sunshine, and a snow sensor detecting a snowfall. The peripheral information detecting sensor may be at least one of an ultrasonic sensor, a radar device, and a LIDAR device (Light detection and Ranging device, or Laser imaging detection and ranging device).

Each of the imaging section 7410 and the outside-vehicle information detecting section 7420 may be provided as an independent sensor or device, or may be provided as a device in which a plurality of sensors or devices are integrated.

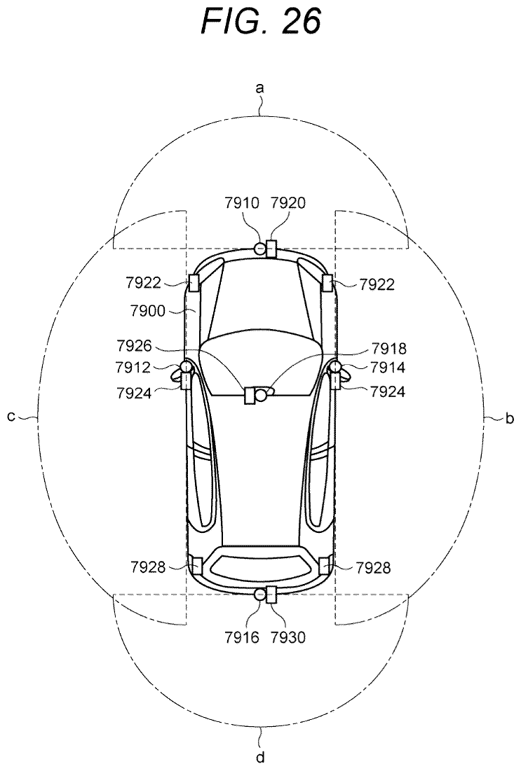

Here, FIG. 26 illustrates an example of installation positions of the imaging section 7410 and the outside-vehicle information detecting section 7420.

Imaging sections 7910, 7912, 7914, 7916, and 7918 are, for example, disposed at at least one of positions on a front nose, sideview mirrors, a rear bumper, and a back door of the vehicle 7900 and a position on an upper portion of a windshield within the interior of the vehicle. The imaging section 7910 provided to the front nose and the imaging section 7918 provided to the upper portion of the windshield within the interior of the vehicle obtain mainly an image of the front of the vehicle 7900. The imaging sections 7912 and 7914 provided to the sideview mirrors obtain mainly an image of the sides of the vehicle 7900. The imaging section 7916 provided to the rear bumper or the back door obtains mainly an image of the rear of the vehicle 7900. The imaging section 7918 provided to the upper portion of the windshield within the interior of the vehicle is used mainly to detect a preceding vehicle, a pedestrian, an obstacle, a signal, a traffic sign, a lane, or the like.

Note that FIG. 26 illustrates an example of the imaging range of each of the imaging sections 7910, 7912, 7914, and 7916. An imaging range a represents the imaging range of the imaging section 7910 provided to the front nose. Imaging ranges b and c respectively represent the imaging ranges of the imaging sections 7912 and 7914 provided to the sideview mirrors. An imaging range d represents the imaging range of the imaging section 7916 provided to the rear bumper or the back door. A bird's-eye image of the vehicle 7900 as viewed from above can be obtained by superimposing image data imaged by the imaging sections 7910, 7912, 7914, and 7916, for example.

Outside-vehicle information detecting sections 7920, 7922, 7924, 7926, 7928, and 7930 provided to the front, rear, sides, and corners of the vehicle 7900 and the upper portion of the windshield within the interior of the vehicle may be, for example, an ultrasonic sensor or a radar device. The outside-vehicle information detecting sections 7920, 7926, and 7930 provided to the front nose of the vehicle 7900, the rear bumper, the back door of the vehicle 7900, and the upper portion of the windshield within the interior of the vehicle may be a LIDAR device, for example. These outside-vehicle information detecting sections 7920 to 7930 are used mainly to detect a preceding vehicle, a pedestrian, an obstacle, or the like.

Returning to FIG. 25, the description will be continued. The outside-vehicle information detecting unit 7400 makes the imaging section 7410 image an image of the outside of the vehicle, and receives imaged image data. In addition, the outside-vehicle information detecting unit 7400 receives detection information from the outside-vehicle information detecting section 7420 connected to the outside-vehicle information detecting unit 7400. In a case where the outside-vehicle information detecting section 7420 is an ultrasonic sensor, a radar device, or a LIDAR device, the outside-vehicle information detecting unit 7400 transmits an ultrasonic wave, an electromagnetic wave, or the like, and receives information of a received reflected wave. On the basis of the received information, the outside-vehicle information detecting unit 7400 may perform processing of detecting an object such as a human, a vehicle, an obstacle, a sign, a character on a road surface, or the like, or processing of detecting a distance thereto. The outside-vehicle information detecting unit 7400 may perform environment recognition processing of recognizing a rainfall, a fog, road surface conditions, or the like on the basis of the received information. The outside-vehicle information detecting unit 7400 may calculate a distance to an object outside the vehicle on the basis of the received information.

In addition, on the basis of the received image data, the outside-vehicle information detecting unit 7400 may perform image recognition processing of recognizing a human, a vehicle, an obstacle, a sign, a character on a road surface, or the like, or processing of detecting a distance thereto. The outside-vehicle information detecting unit 7400 may subject the received image data to processing such as distortion correction, alignment, or the like, and combine the image data imaged by a plurality of different imaging sections 7410 to generate a bird's-eye image or a panoramic image. The outside-vehicle information detecting unit 7400 may perform viewpoint conversion processing using the image data imaged by the imaging section 7410 including the different imaging parts.

The in-vehicle information detecting unit 7500 detects information about the inside of the vehicle. The in-vehicle information detecting unit 7500 is, for example, connected with a driver state detecting section 7510 that detects the state of a driver. The driver state detecting section 7510 may include a camera that images the driver, a biosensor that detects biological information of the driver, a microphone that collects sound within the interior of the vehicle, or the like. The biosensor is, for example, disposed in a seat surface, the steering wheel, or the like, and detects biological information of an occupant sitting in a seat or the driver holding the steering wheel. On the basis of detection information input from the driver state detecting section 7510, the in-vehicle information detecting unit 7500 may calculate a degree of fatigue of the driver or a degree of concentration of the driver, or may determine whether the driver is dozing. The in-vehicle information detecting unit. 7500 may subject an audio signal obtained by the collection of the sound to processing such as noise canceling processing or the like.

The integrated control unit 7600 controls general operation within the vehicle control system 7000 in accordance with various kinds of programs. The integrated control unit 7600 is connected with an input section 7800. The input section 7800 is implemented by a device capable of input operation by an occupant, such, for example, as a touch panel, a button, a microphone, a switch, a lever, or the like. The integrated control unit 7600 may be supplied with data obtained by voice recognition of voice input through the microphone. The input section 7800 may, for example, be a remote control device using infrared rays or other radio waves, or an external connecting device such as a mobile telephone, a personal digital assistant (PDA), or the like that supports operation of the vehicle control system 7000. The input section 7800 may be, for example, a camera. In that case, an occupant can input information by gesture. Alternatively, data may be input which is obtained by detecting the movement of a wearable device that an occupant wears. Further, the input section 7800 may, for example, include an input control circuit or the like that generates an input signal on the basis of information input by an occupant or the like using the above-described input section 7800, and which outputs the generated input signal to the integrated control unit 7600. An occupant or the like inputs various kinds of data or gives an instruction for processing operation to the vehicle control system 7000 by operating the input section 7800.

The storage section 7690 may include a read only memory (ROM) that stores various kinds of programs executed by the microcomputer and a random access memory (RAM) that stores various kinds of parameters, operation results, sensor values, or the like. In addition, the storage section 7690 may be implemented by a magnetic storage device such as a hard disc drive (HDD) or the like, a semiconductor storage device, an optical storage device, a magneto-optical storage device, or the like.

The general-purpose communication I/F 7620 is a communication I/F used widely, which communication I/F mediates communication with various apparatuses present in an external environment 7750. The general-purpose communication I/F 7620 may implement a cellular communication protocol such as global system for mobile communications (GSM (registered trademark) ), worldwide interoperability for microwave access (WiMAX (registered trademark) ), long term evolution (LTE (registered trademark) ), LTE-advanced (LTE-A), or the like, or another wireless communication protocol such as wireless LAN (referred to also as wireless fidelity (Wi-Fi (registered trademark) ), Bluetooth (registered trademark), or the like. The general-purpose communication I/F 7620 may, for example, connect to an apparatus (for example, an application server or a control server) present on an external network (for example, the Internet, a cloud network, or a company-specific network) via a base station or an access point. In addition, the general-purpose communication I/F 7620 may connect to a terminal present in the vicinity of the vehicle (which terminal is, for example, a terminal of the driver, a pedestrian, or a store, or a machine type communication (MTC) terminal) using a peer to peer (P2P) technology, for example.

The dedicated communication I/F 7630 is a communication I/F that supports a communication protocol developed for use in vehicles. The dedicated communication I/F 7630 may implement a standard protocol such, for example, as wireless access in vehicle environment (WAVE), which is a combination of institute of electrical and electronic engineers (IEEE) 802.11p as a lower layer and IEEE 1609 as a higher layer, dedicated short range communications (DSRC), or a cellular communication protocol. The dedicated communication I/F 7630 typically carries out V2X communication as a concept including one or more of communication between a vehicle and a vehicle (Vehicle to Vehicle), communication between a road and a vehicle (Vehicle to Infrastructure), communication between a vehicle and a home (Vehicle to Home), and communication between a pedestrian and a vehicle (Vehicle to Pedestrian).

The positioning section 7640, for example, performs positioning by receiving a global navigation satellite system (GNSS) signal from a GNSS satellite (for example, a GPS signal from a global positioning system (GPS) satellite), and generates positional information including the latitude, longitude, and altitude of the vehicle. Incidentally, the positioning section 7640 may identify a current position by exchanging signals with a wireless access point, or may obtain the positional information from a terminal such as a mobile telephone, a personal handyphone system (PHS), or a smart phone that has a positioning function.

The beacon receiving section 7650, for example, receives a radio wave or an electromagnetic wave transmitted from a radio station installed on a road or the like, and thereby obtains information about the current position, congestion, a closed road, a necessary time, or the like. Incidentally, the function of the beacon receiving section 7650 may be included in the dedicated communication I/F 7630 described above.

The in-vehicle device I/F 7660 is a communication interface that mediates connection between the microcomputer 7610 and various in-vehicle devices 7760 present within the vehicle. The in-vehicle device I/F 7660 may establish wireless connection using a wireless communication protocol such as wireless LAN, Bluetooth (registered trademark), near field communication (NFC), or wireless universal serial bus (WUSB). In addition, the in-vehicle device I/F 7660 may establish wired connection by universal serial bus (USB), high-definition multimedia interface (HDMI (registered trademark) ), mobile high-definition link (MHL), or the like via a connection terminal (and a cable if necessary) not. depicted in the figures. The in-vehicle devices 7760 may, for example, include at least one of a mobile device and a wearable device possessed by an occupant and an information device carried into or attached to the vehicle. The in-vehicle devices 7760 may also include a navigation device that searches for a path to an arbitrary destination. The in-vehicle device I/F 7660 exchanges control signals or data signals with these in-vehicle devices 7760.

The vehicle-mounted network I/F 7680 is an interface that mediates communication between the microcomputer 7610 and the communication network 7010. The vehicle-mounted network I/F 7680 transmits and receives signals or the like in conformity with a predetermined protocol supported by the communication network 7010.

The microcomputer 7610 of the integrated control unit 7600 controls the vehicle control system 7000 in accordance with various kinds of programs on the basis of information obtained via at least one of the general-purpose communication I/F 7620, the dedicated communication I/F 7630, the positioning section 7640, the beacon receiving section 7650, the in-vehicle device I/F 7660, and the vehicle-mounted network I/F 7680. For example, the microcomputer 7610 may calculate a control target value for the driving force generating device, the steering mechanism, or the braking device on the basis of the obtained information about the inside and outside of the vehicle, and output a control command to the driving system control unit 7100. For example, the microcomputer 7610 may perform cooperative control intended to implement functions of an advanced driver assistance system (ADAS) which functions include collision avoidance or shock mitigation for the vehicle, following driving based on a following distance, vehicle speed maintaining driving, a warning of collision of the vehicle, a warning of deviation of the vehicle from a lane, or the like. In addition, the microcomputer 7610 may perform cooperative control intended for automated driving, which makes the vehicle to travel automatedly without depending on the operation of the driver, or the like, by controlling the driving force generating device, the steering mechanism, the braking device, or the like on the basis of the obtained information about the surroundings of the vehicle.

The microcomputer 7610 may generate three-dimensional distance information between the vehicle and an object such as a surrounding structure, a person, or the like, and generate local map information including information about the surroundings of the current position of the vehicle, on the basis of information obtained via at least one of the general-purpose communication I/F 7620, the dedicated communication I/F 7630, the positioning section 7640, the beacon receiving section 7650, the in-vehicle device I/F 7660, and the vehicle-mounted network I/F 7680. In addition, the microcomputer 7610 may predict danger such as collision of the vehicle, approaching of a pedestrian or the like, an entry to a closed road, or the like on the basis of the obtained information, and generate a warning signal. The warning signal may, for example, be a signal for producing a warning sound or lighting a warning lamp.

The sound/image output section 7670 transmits an output signal of at least one of a sound and an image to an output device capable of visually or auditorily notifying information to an occupant of the vehicle or the outside of the vehicle. In the example in FIG. 25, an audio speaker 7710, a display section 7720, and an instrument panel 7730 are illustrated as output devices. The display section 7720 may, for example, include at least one of an on-board display and a head-up display. The display section 7720 may have an augmented reality (AR) display function. The output device may be other than these devices, and may be another device such as headphones, a wearable device such as an eyeglass type display worn by an occupant or the like, a projector, a lamp, or the like. In a case where the output device is a display device, the display device visually displays results obtained by various kinds of processing performed by the microcomputer 7610 or information received from another control unit in various forms such as text, an image, a table, a graph, or the like. In addition, in a case where the output device is an audio output device, the audio output device converts an audio signal constituted of reproduced audio data or sound data or the like into an analog signal, and auditorily outputs the analog signal.

Note that, in the example illustrated in FIG. 25, at least two control units connected to each other via the communication network 7010 may be integrated into a single control unit. Alternatively, each individual control unit may include a plurality of control units. Further, the vehicle control system 7000 may include another control unit not depicted in the figures. In addition, part or the whole of the functions performed by one of the control units in the above description may be assigned to another control unit. That is, predetermined arithmetic processing may be performed by any of the control units as long as information is transmitted and received via the communication network 7010. Similarly, a sensor or a device connected to one of the control units may be connected to another control unit, and a plurality of control units may mutually transmit and receive detection information via the communication network 7010.

In the vehicle control system 7000 described above, the light detecting device 1 according to the present embodiment described with reference to FIG. 2 and the like can be applied to the outside-vehicle information detecting unit 7400 of the application example illustrated in FIG. 25.

Note that the present technology may have the following configurations.

(1) A light detecting device including:
a first counter group including at least two first counters;
a first pixel circuit or a first pixel circuit group connected to the first counter group;
a first pixel connected to the first pixel circuit or a first pixel group connected to the first pixel circuit group;
a second counter group including at least two second counters;
a second pixel circuit or a second pixel circuit group connected to the second counter group;
a second pixel connected to the second pixel circuit or a second pixel group connected to the second pixel circuit group; and
a switching circuit that switches between counting the number of transitions of an output signal of the first pixel circuit or the first pixel circuit group using the first counter group without using the second counter group and counting the number of transitions using both the first counter group and the second counter group.

(2) The light detecting device according to (1), in which
the first pixel or the first pixel group includes an active pixel or an active pixel group used to receive reflected light from an object, and
the second pixel or the second pixel group includes an inactive pixel or an inactive pixel group not used to receive the reflected light.

(3) The light detecting device according to (1) or (2), further including:
a mode selection unit that selects a first mode in which the number of transitions of the output signal of the first pixel circuit or the first pixel circuit group is counted using the first counter group without using the second counter group, or a second mode in which the number of transitions is counted using both the first counter group and the second counter group, in which
the switching circuit performs switching in accordance with the selection made by the mode selection unit.

(4) The light detecting device according to (3), in which
count values of the first counter group and the second counter group are used to measure a distance to an object,
in a case where the second mode is selected, a measurable range is longer than in a case where the first. mode is selected, and
regardless of whether the first mode or the second mode is selected, a distance resolution and a resolution are the same.

(5) The light detecting device according to (4), in which
the measurable range in a case where the second mode is selected is equal to an integral multiple of at least twice the measurable range in a case where the first mode is selected.

(6) The light detecting device according to any one of (3) to (5), in which
each of the first and second modes further includes a third mode and a fourth mode that are exclusively selectable,
in the third mode, the number of transitions of the output signal of the first pixel circuit or the first pixel circuit group is counted using one of the first counter groups, and
in the fourth mode, the number of transitions of the output signal of the first pixel circuit or the first pixel circuit group is counted using a plurality of the first counter groups.

(7) The light detecting device according to (6), in which
the fourth mode further includes a fifth mode, a sixth mode, and a seventh mode that are exclusively selectable,
the sixth mode is longer in measurable range than the fifth mode, lower in distance resolution than the fifth mode, and the same in resolution as the fifth mode, and
the seventh mode is longer in measurable range than the fifth mode and the same in distance resolution and resolution as the fifth mode.

(8) The light detecting device according to any one of (1) to (7), further including:
a first substrate including a pixel array unit in which a plurality of the first pixels or the first pixel groups and a plurality of the second pixels or the second pixel groups are arranged; and
a second substrate in which a plurality of the first pixel circuits or the first pixel circuit groups, a plurality of the first counter groups, a plurality of the second pixel circuits or the second pixel circuit groups, a plurality of the second counter groups, and a plurality of the switching circuits are arranged, the second substrate being stacked on the first substrate.

(9) The light detecting device according to (8), in which
the plurality of first pixels or the plurality of first pixel groups is arranged in a predetermined pixel region in the pixel array unit, and
the plurality of second pixels or the plurality of second pixel groups is arranged in a pixel region other than the predetermined pixel region in the pixel array unit.

(10) The light detecting device according to any one of (3) to (7), further including:
an output unit that generates output data including first bit string data and second bit string data, the first bit string data including information regarding a mode selected by the mode selection unit, the second bit string data including a count value of the first counter group when the first mode is selected or count values of both the first and second counter groups when the second mode is selected; and an output unit that generates a signal.

(11) The light detecting device according to (10), in which
the first bit string data includes information regarding the number of the second counter groups connected to the first counter group when the second mode is selected.

(12) The light detecting device according to (10) or (11), in which
the first bit string data includes information used to identify whether to perform binning processing of conducting counting using at least two of the first counter groups or to conduct counting using one of the first counter groups.

(13) The light detecting device according to any one of (10) to (12), in which
the first bit string data includes information used to identify whether to count the number of transitions within a specific pixel region of interest or to count the number of transitions within a predetermined partial pixel region.

(14) The light detecting device according to any one of (10) to (13), in which
the second bit string data includes a plurality of pieces of bit string data in which the count values of the first and second counter groups corresponding to each of all the first pixels are arranged in pixel order when the second mode is selected.

(15) The light detecting device according to any one of (1) to (14), further including:
a first pixel array unit in which a plurality of the first pixels or the first pixel groups and a plurality of the second pixels or the second pixel groups and arranged;
a second pixel array unit in which a plurality of third pixels that individually captures subject light is arranged; and
a control unit that controls a light reception range of the second pixel array unit in accordance with a focal length of the subject light incident on the second pixel array unit.

(16) The light detecting device according to (15), in which
in a case of controlling the focal length of the second pixel array unit toward a telephoto side, the control unit further reduces a size of a pixel region of the plurality of first pixels or the plurality of first pixel groups in the first pixel array unit.

(17) The light detecting device according to (15) or (16), further including:
an optical system driving unit that drives a focus-adjustable optical system that adjusts the focal length of the subject light incident on the second pixel array unit, in which
the control unit controls the optical system driving unit on the basis of a measurement result of a distance to the object based on reflected light from the object received by the plurality of first pixels or the plurality of first pixel groups in the first pixel array unit.

(18) A ranging system including:
a light emitting device that irradiates an object with light;
a light receiving unit that receives reflected light resulting from the light emitted by the light emitting device and reflected by the object;
a ranging unit that measures a distance to the object on the basis of the light emitted by the light emitting device and the reflected light received by the light receiving unit; and
a control unit that controls the light emitting device, the light receiving unit, and the ranging unit, in which
the light receiving unit includes:
a pixel array unit including a plurality of first pixels or first pixel groups and a plurality of second pixels or second pixel groups;
a plurality of first pixel circuits connected to the plurality of first pixels or a plurality of first pixel circuit groups connected to the plurality of first pixel groups;
a first counter group provided for each of the plurality of first pixel circuits or the plurality of first pixel circuit groups, the first counter group including a plurality of first counters;
a plurality of second pixel circuits connected to the plurality of second pixels or a plurality of second pixel circuit groups connected to the plurality of second pixel groups;
a second counter group provided for each of the plurality of second pixel circuits or the plurality of second pixel circuit groups, the second counter group including a plurality of second counters; and
a switching circuit that switches between counting the number of transitions of each of output signals of the plurality of first pixel circuits or the plurality of first pixel circuit groups using the corresponding first counter group without using the corresponding second counter group and counting the number of transitions using both the corresponding first counter group and the corresponding second counter group.

(19) The ranging system according to (18), in which
the light emitting device includes a plurality of light emitting units capable of individually controlling whether or not to emit light on the basis of the control of the control unit, and
the control unit controls a size of a light emission area that emits light among the plurality of light emitting units in conjunction with a size of a pixel region of the plurality of first pixels or the plurality of first pixel groups in the pixel array unit.

Aspects of the present disclosure are not limited to the above-described individual embodiments, but include various modifications that can be conceived by those skilled in the art, and the effects of the present disclosure are not limited to the above-described effects. That is, various additions, modifications, and partial deletions are possible without departing from the conceptual idea and spirit of the present disclosure derived from the matters defined in the claims and equivalents thereof.

### REFERENCE SIGNS LIST

1 Light detecting device
2 Ranging system
3 Application unit
4 Light emitting device
5 Host control unit
6 Object
9 Current source
11 Light receiving unit
12 Ranging processing unit
13 Control unit
14 Ranging control unit
15 Light emitting timing control unit
16 Clock generation unit
17 Pixel control unit
18 I/F unit
19 Pixel array unit
20 Pixel
20a Active pixel
20n Inactive pixel
22 AFE unit
23 Generation unit
24 Ranging unit
25 First pixel circuit
25 Pixel circuit
25a Active pixel circuit
25n Inactive pixel circuit
26 Inverter
27 Distribution circuit
27a First distribution circuit 27a
27n Second distribution circuit
28 Counter group
28a First counter group
28n Second counter group
29 Histogram generation unit
30 Switch
30g Pixel group
31 Counter
31a First counter
31n Second counter
32 OR circuit
32a OR circuit
32n OR circuit.
33 Counter switching circuit
40 Semiconductor chip
41 Light emitting element
44 First substrate
45 Second substrate
46 Register
47 Pixel setting unit
48 Distribution setting unit
49 Register
50 Output circuit
53 Wiring line
54 ROI area
55 Wiring line
56 Spot area
60 OR circuit
61 Imaging unit
62 AF lens driver

1. A light detecting device comprising:
a first counter group including at least two first counters;
a first pixel circuit or a first pixel circuit group connected to the first counter group;
a first pixel connected to the first pixel circuit or a first pixel group connected to the first pixel circuit group;
a second counter group including at least two second counters;
a second pixel circuit or a second pixel circuit group connected to the second counter group;
a second pixel connected to the second pixel circuit or a second pixel group connected to the second pixel circuit group; and
a switching circuit that switches between counting a number of transitions of an output signal of the first pixel circuit or the first pixel circuit group using the first counter group without using the second counter group and counting the number of transitions using both the first counter group and the second counter group.

2. The light detecting device according to claim 1, wherein
the first pixel or the first pixel group includes an active pixel or an active pixel group used to receive reflected light from an object, and
the second pixel or the second pixel group includes an inactive pixel or an inactive pixel group not used to receive the reflected light.

3. The light detecting device according to claim 1, further comprising:
a mode selection unit that selects a first mode in which the number of transitions of the output signal of the first pixel circuit or the first pixel circuit group is counted using the first counter group without using the second counter group, or a second mode in which the number of transitions is counted using both the first counter group and the second counter group, wherein
the switching circuit performs switching in accordance with the selection made by the mode selection unit.

4. The light detecting device according to claim 3, wherein
count values of the first counter group and the second counter group are used to measure a distance to an object,
in a case where the second mode is selected, a measurable range is longer than in a case where the first mode is selected, and
regardless of whether the first mode or the second mode is selected, a distance resolution and a resolution are the same.

5. The light detecting device according to claim 4, wherein
the measurable range in a case where the second mode is selected is equal to an integral multiple of at least twice the measurable range in a case where the first mode is selected.

6. The light detecting device according to claim 3, wherein
each of the first and second modes further includes a third mode and a fourth mode that are exclusively selectable,
in the third mode, the number of transitions of the output signal of the first pixel circuit or the first pixel circuit group is counted using one of the first counter groups, and
in the fourth mode, the number of transitions of the output signal of the first pixel circuit or the first pixel circuit group is counted using a plurality of the first counter groups.

7. The light detecting device according to claim 6, wherein
the fourth mode further includes a fifth mode, a sixth mode, and a seventh mode that are exclusively selectable,
the sixth mode is longer in measurable range than the fifth mode, lower in distance resolution than the fifth mode, and the same in resolution as the fifth mode, and
the seventh mode is longer in measurable range than the fifth mode and the same in distance resolution and resolution as the fifth mode.

8. The light detecting device according to claim 1, further comprising:
a first substrate including a pixel array unit in which a plurality of the first pixels or the first pixel groups and a plurality of the second pixels or the second pixel groups are arranged; and
a second substrate in which a plurality of the first pixel circuits or the first pixel circuit groups, a plurality of the first counter groups, a plurality of the second pixel circuits or the second pixel circuit groups, a plurality of the second counter groups, and a plurality of the switching circuits are arranged, the second substrate being stacked on the first substrate.

9. The light detecting device according to claim 8, wherein
the plurality of first pixels or the plurality of first pixel groups is arranged in a predetermined pixel region in the pixel array unit, and
the plurality of second pixels or the plurality of second pixel groups is arranged in a pixel region other than the predetermined pixel region in the pixel array unit.

10. The light detecting device according to claim 3, further comprising:
an output unit that generates output data including first bit string data and second bit string data, the first bit string data including information regarding a mode selected by the mode selection unit, the second bit string data including a count value of the first counter group when the first mode is selected or count values of both the first and second counter groups when the second mode is selected.

11. The light detecting device according to claim 10, wherein
the first bit string data includes information regarding a number of the second counter groups connected to the first counter group when the second mode is selected.

12. The light detecting device according to claim 10, wherein
the first bit string data includes information used to identify whether to perform binning processing of conducting counting using at least two of the first counter groups or to conduct counting using one of the first counter groups.

13. The light detecting device according to claim 10, wherein
the first bit string data includes information used to identify whether to count the number of transitions within a specific pixel region of interest or to count the number of transitions within a predetermined partial pixel region.

14. The light detecting device according to claim 10, wherein
the second bit string data includes a plurality of pieces of bit string data in which the count values of the first and second counter groups corresponding to each of all the first pixels are arranged in pixel order when the second mode is selected.

15. The light detecting device according to claim 1, further comprising:
a first pixel array unit in which a plurality of the first pixels or the first pixel groups and a plurality of the second pixels or the second pixel groups and arranged;
a second pixel array unit in which a plurality of third pixels that individually captures subject light is arranged; and
a control unit that controls a light reception range of the second pixel array unit in accordance with a focal length of the subject light incident on the second pixel array unit.

16. The light detecting device according to claim 15, wherein
in a case of controlling the focal length of the second pixel array unit toward a telephoto side, the control unit further reduces a size of a pixel region of the plurality of first pixels or the plurality of first pixel groups in the first pixel array unit.

17. The light detecting device according to claim 15, further comprising:
an optical system driving unit that drives a focus-adjustable optical system that adjusts the focal length of the subject light incident on the second pixel array unit, wherein
the control unit controls the optical system driving unit on a basis of a measurement result of a distance to the object based on reflected light from the object received by the plurality of first pixels or the plurality of first pixel groups in the first pixel array unit.

18. A ranging system comprising:
a light emitting device that irradiates an object with light;
a light receiving unit that receives reflected light resulting from the light emitted by the light emitting device and reflected by the object;
a ranging unit that measures a distance to the object on a basis of the light emitted by the light emitting device and the reflected light received by the light receiving unit; and
a control unit that controls the light emitting device, the light receiving unit, and the ranging unit, wherein
the light receiving unit includes:
a pixel array unit including a plurality of first pixels or first pixel groups and a plurality of second pixels or second pixel groups;
a plurality of first pixel circuits connected to the plurality of first pixels or a plurality of first pixel circuit groups connected to the plurality of first pixel groups;
a first counter group provided for each of the plurality of first pixel circuits or the plurality of first pixel circuit groups, the first counter group including a plurality of first counters;
a plurality of second pixel circuits connected to the plurality of second pixels or a plurality of second pixel circuit groups connected to the plurality of second pixel groups;
a second counter group provided for each of the plurality of second pixel circuits or the plurality of second pixel circuit groups, the second counter group including a plurality of second counters; and
a switching circuit that switches between counting a number of transitions of each of output signals of the plurality of first pixel circuits or the plurality of first pixel circuit groups using the corresponding first counter group without using the corresponding second counter group and counting the number of transitions using both the corresponding first counter group and the corresponding second counter group.

19. The ranging system according to claim 18, wherein
the light emitting device includes a plurality of light emitting units capable of individually controlling whether or not to emit light on a basis of the control of the control unit, and
the control unit controls a size of a light emission area that emits light among the plurality of light emitting units in conjunction with a size of a pixel region of the plurality of first pixels or the plurality of first pixel groups in the pixel array unit.
